(19) United States
(12) Patent Application Publication
(10) Pub. No.: US 2017/0316708 A1
(43) Pub. Date: Nov. 2, 2017

(54) SYSTEMS AND METHODS FOR PROVIDING WORD DEFINITIONS BASED ON USER EXPOSURE

(71) Applicant: Rovi Guides, Inc., San Carlos, CA (US)

(72) Inventors: Reda Harb, Bellevue, WA (US); George Oehling, Bellevue, WA (US)

(21) Appl. No.: 15/143,147

(22) Filed: Apr. 29, 2016

(51) Int. Cl. G09B 5/12; H04N 21/442; G09B 19/00; H04N 21/433; H04N 21/475; H04N 21/45

(52) U.S. Cl. CPC G09B 5/125; H04N 21/4755; H04N 21/4532; G09B 19/00; H04N 21/4333; H04N 21/44222

(57) ABSTRACT

Systems and methods are disclosed herein for providing a definition of a word encountered by the user during media consumption when a profile of the user reflects an insufficient understanding of the word. To this end, a media guidance application may detect a word appearing in media, and may determine that the word satisfies a user-specific criterion. Further, the media guidance application may determine that the exposure of the user to the word reflects an insufficient understanding of the word by calculating the level of exposure of the user to the word and comparing the level of exposure to an exposure criterion. The media guidance application may then provide a definition of the word to the user.

### BACKGROUND

When a user encounters a difficult word during media consumption, it is conventional to display a definition of the word in order to expand the user's vocabulary knowledge. While providing a definition is useful when a user encounters a difficult word for the first time, providing the definition without considering whether the word meets the user's word definition preferences and without considering the amount of exposure that the user has had to the word may be ineffective for improving the user's understanding of the word, and may even be detrimental to the user's learning process of new words in general.

### SUMMARY

Accordingly, methods and systems are described for a media guidance system that can detect that a word encountered during media consumption satisfies a user criterion, and that the user's previous exposure to the word reflects an insufficient understanding of the word. The media guidance application may then provide a definition of the word to the user. For example, the media guidance application may provide a definition of the word “intransigent” to the user, because the word “intransigent” satisfies a user-specific criterion indicating that words having twelve or more characters should be defined for the user, and because the media guidance determined that the user has not been sufficiently exposed to the word “intransigent” in the past.

To this end in some embodiments, a media guidance application executed by control circuitry of a user equipment may access the profile of the user. The profile of the user may contain the media consumption history of the user, the user's web history, as well as a directory of words, with each word in the directory of words corresponding to a word that the user had encountered during media consumption. In addition, the media guidance may correlate each word to a history of the user's exposure to the word. The profile may also contain user-specific criteria for words and idioms, and exposure criteria that specify the frequency with which the user is to be exposed to certain words in order to sufficiently understand those words.

In some embodiments, the media guidance application may detect that a word that satisfies a user-specific criterion has been encountered by the user during consumption of media by the user. For example, the media guidance application may detect, during playback of a news program on user equipment, that the word “intransigent” was spoken by a commentator. Further, the media guidance application may determine that the word “intransigent,” having twelve characters, satisfies a user-specific criterion indicating that words having twelve or more characters are be defined for the user. The media guide application may utilize the user-specific criterion in order to limit the number of word definitions that the media guidance application provides to the user by distinguishing between words the user already understands, and those words that the user is likely not to sufficiently understand. The net effect of this is that the media guidance application optimizes the user's learning process by providing definitions in situations when the user is likely to insufficiently understand a given word.

In some embodiments, the media guidance application may receive a user request to specify a user-defined value for the user-specific criterion, where the user-specific criterion describes a minimum word length. For example, the user may find that he or she does not sufficiently understand words having twelve or more characters. Accordingly, the media guidance application may receive a user input, by way of an input device, specifying that the user wishes to see definitions of words of twelve or more characters.

In some embodiments, the media guidance application may receive a user-defined value for the user-specific criterion. For example, the media guidance application may generate for display an option (e.g., an option to specify a minimum number of characters for words appearing in media) on a display screen and may subsequently receive an input from the user selecting an option that specifies the minimum number of characters that a word is to have in order for the media guidance application to provide a definition of the word to the user.

In some embodiments, the media guidance application may receive a user input, by way of an input device, specifying that the media guidance application is to provide definitions of words of having a certain minimum length (e.g., twelve characters or more). In this way, the media guidance application may only provide definitions of words that satisfy the user criteria, without burdening the user with definitions of words that the user likely already sufficiently understands.

In some embodiments, the media guidance application may update the value of the user-specific criterion with the user-defined value, where detecting that the word that satisfies the user-specific criterion has been encountered by the user during consumption of media by the user includes determining that the word has a length that equals or exceeds the minimum word length. For example, the media guidance application may store, in storage, the user-specific criterion that specifies a minimum word length. The media guidance application may store the user-specific criterion in a profile of the user stored in the storage of the user equipment. When the media guidance application begins playing media, the media guidance application may query the storage to determine the user-specific criterion. When a word in the media equals or exceeds the minimum word length (e.g., twelve characters), the media guidance application may then provide a definition of the word to the user, assuming that the user's level of exposure to the word reflects an insufficient level of understanding of the word, as will be described in greater detail below.

A given media asset may contain a large number of words satisfying a user-specific criterion, to the point that the provided definitions interfere with the user's viewing experience. For example, when a user sets a user-specific criterion to a less encompassing value (e.g., a minimum word length of six characters), the media guidance application may provide a large number of definitions when the user is consuming media characterized by more difficult language (e.g., such as a program about advanced astronomy-related concepts), in which the narrator uses many words that satisfy the criterion (e.g., words of six characters of more). Thus, it is advantageous for the media guidance application to automatically determine a value for the user-specific criterion, such that the number of definitions does not overwhelm the user. However, when the media consumed by the user contains less difficult language, the media guidance application may lower the user-specific criterion to a more encompassing value, such that the media guidance application provides the user with all definitions that the user may wish to view. Thus, the media guidance application may determine the value of the user-specific criterion based on the types of words present in the language of the media consumed by the user, so that both the user's learning experience and media consumption experience is optimized.

Accordingly, in some embodiments, the media guidance application may store, in the profile of the user, a history of words encountered by the user during media consumption, where the history comprises each encountered word, and where a given word of the history of words corresponds to a characteristic value that conveys a likelihood that the user may insufficiently understand the given word. For example, the media guidance application may monitor the user's consumption of movies, television programming, music, and radio. The media guidance application may detect a word (e.g., “intransigent”) in the media being watched by the user at a given point in time. The media guidance application may update an entry in the history of words to indicate that the user has encountered a new instance of the word. Further, the media guidance application may associate each word stored in the history with a characteristic value (e.g., word length). In this example, the media guidance application associates the word “intransigent” with the number twelve (i.e., the number of characters in the word). Based on the characteristic value, the media guidance application may determine whether a given word is unlikely to be sufficiently understood by the user.

In some embodiments, the media guidance application may compute a mean characteristic value of a set of words of the history of words. For example, the media guidance application may query the history of words and determine that a mean characteristic value (e.g., the word length) is seven (e.g., seven characters).

In some embodiments, the media guidance application may compute a standard deviation of the characteristic value of the set of words of the history of words. For example, the media guidance application may determine that the standard deviation of the set of words is two characters. In other words, in this particular example, and based on the mean characteristic value of seven characters, the majority of words encountered by the user have a length between five and nine characters.

In some embodiments, the media guidance application may compute a recommended value based on the mean characteristic value and the standard deviation of the characteristic value. The net effect of this calculation is that the media guidance application may effectively determine that a word may be insufficiently understood by the user if the word belongs to a set of the longest words and therefore the words that are most likely to be difficult for the user to understand. For example, the media guidance application may multiply the standard deviation of the characteristic value by two and then may add the resultant product to the mean characteristic value. In other words, by the mathematical definition of standard deviation, the media guidance application may effectively determine a minimum number of characters for the user-specific criterion, such that the media guidance application defines only 2.3% of the most difficult words appearing in a media asset (e.g., words that are eleven or more characters in length). In such a way, the media guidance application provides the user with definitions of the longest (and therefore most likely to be insufficiently understood by the user) words that the user is very likely not to understand, so that the user can otherwise enjoy an uninterrupted media consumption experience.

In addition to providing definitions of individual words, the media guidance application may provide definitions of idioms to the user. Because idioms comprise specific words that follow a specific word order, the media guidance application may use a user-specific criterion tailored for detecting idioms. Additionally, the media guidance application may utilize the user-specific criterion to define words that meet the user's preference. Accordingly, in some embodiments, the media guidance application may detect a sequence of words. For example, the media guidance application may detect a sequence of words “burning the midnight oil” which corresponds to the idiom “burn the midnight oil.” The media guidance application may detect the sequence of words based on certain keywords that are characteristic of idioms. For example, the media guidance application may store the word “midnight” in an idiom dictionary and reference the corresponding idiom “burn the midnight oil,” and upon detecting that the word “midnight” appears in the media, the media guidance application may detect other words appearing in close proximity, such as “the,” “midnight,” and “oil.”

When detecting the sequence of words, the media guidance application may limit the number of words in the sequence by determining the number of words in the idiom. For example, the media guidance application may detect the word “midnight,” and subsequently determine that the media may be referring to the idiom “burn the midnight oil.” The media guidance application may then count the number of words appearing in the idiom (e.g., four words). Thus, the media guidance application may detect three additional words in order to complete the sequence (e.g., “the midnight oil”).

In some embodiments, the media guidance application may compare the sequence of words to a plurality of idiom templates consisting of terms. For example, the media guidance application may compare the sequence “burning the midnight oil” to idiom templates stored in an idiom dictionary. Idiom templates contain the keywords of an idiom arranged according to the order that they appear in the idiom. An idiom template may exclude the articles and prepositions that are present in the idiom itself. This is because such words marginally contribute to determining whether a sequence of words corresponds to an idiom, and because such words may be arbitrarily moved or dropped during colloquial speech. For example, an idiom template corresponding to the idiom “burn the midnight oil” may be represented by the string “burn midnight oil.” In a similar manner, the media guidance application may process the word sequence to also remove such types of keywords (e.g., the word sequence “burning the midnight oil” becomes “burning midnight oil”).

In some embodiments, the media guidance application may determine an association metric relating to a similarity between the word sequence and the idiom template. The media guidance application may compute a string distance metric between the word sequence (e.g., “burning midnight oil”) and the idiom template (e.g., “burn midnight oil”) to determine whether the idiom corresponding to the idiom template is embedded in the sequence of words. In one example, the media guidance application may determine that the word sequence and the idiom template share two words that are common to both queries. The media guidance application may then set the association metric to the result of the calculation of dividing the number of words common to both word sequence and idiom template by the number of words contained in the idiom template. For example, the media guidance application may determine that the idiom template contains three words. The media guidance application may then set the association metric to the result of dividing the number of words common to both the idiom template and word sequence (e.g., two words) by the number of words in idiom template (e.g., three words). In this example, the media guidance application may set the association metric to the calculated value (e.g., 0.67). A significantly large association metric, which is described further below, may be indicative of the presence of an idiom embedded in the sequence of words. Any form of logic or fuzzy logic may be used to compare the word sequence to the idiom template and to determine a measure of similarity between the word sequence and idiom template.

In some embodiments, the media guidance application may determine whether the association metric meets or exceeds a similarity threshold. For example, the media guidance application may retrieve a similarity threshold stored in a storage device, and compare the threshold to the association metric. The media guidance application may determine a similarity threshold in a number of ways. The threshold may be based on the output of a function, the inputs of which may include the number of terms in the idiom template, the number of words in the word sequence, the number of variations of the idiom, and the measure of significance of each term in the idiom template. The media guidance application may then store the similarity threshold in storage. Additionally, the media guidance application may associate the similarity threshold with the user by storing the similarity threshold in a profile associated with the user.

In some embodiments, in response to determining that the association metric meets or exceeds the similarity threshold, the media guidance application provides to the user the idiom associated with the idiom template and an idiom definition associated with the idiom template. For example, when the media guidance application determines that the value of the association metric (e.g., 0.67) exceeds the value of the similarity threshold (e.g., 0.5), the media guidance application may present the idiom (e.g., “burn the midnight oil”) and an idiom definition (e.g., “read, study, or work late into the night”).

In some embodiments, the media guidance application may determine that an idiom associated with the idiom template is frequently misstated in media. For example, the media guidance application may determine, by comparing the idiom template (e.g., “pique interest”) associated with an idiom (e.g., “pique one's interest”) with sequences of words appearing in media, that the idiom may frequently be misstated. By calculating the association metric as previously described, the media guidance application may determine that the word sequences such as “peek one's interest,” “peak one's interest,” and “peak one's curiosity” are all related to the same idiom.

Accordingly, in some embodiments, the media guidance application may decrease the similarity threshold in response to determining that the idiom associated with the idiom template is frequently misstated in media. For example, the media guidance application may decrease the similarity threshold to account for a high number of variations in which idioms may be presented in the media. In one example, the media guidance application may decrease the similarity threshold to a new value (e.g., 0.50) in order to properly detect word sequences that contain a highly variable idiom (e.g., “pique one's interest”).

In some embodiments, the media guidance application may determine a level of exposure that the user has had to the word based on an entry corresponding to the word in the profile. For example, the media guidance application, upon detecting the word “intransigent,” may search the profile to determine whether the user had been exposed to the word on a previous occasion. For example, the media guidance application may determine that the user had been exposed to the word “intransigent” five times in the past year. Thus, the media guidance application may set the level of exposure corresponding to the word “intransigent” to five.

In some embodiments, the media guidance application may compare the level of exposure to an exposure criterion. An exposure criterion may determine how frequently a user is to be exposed to a given word in order to sufficiently learn and retain understanding of the definition of the word. As will be described further below, the media guidance application may receive a user input selecting a value for the exposure criteria. The media guidance may alternatively calculate an appropriate exposure criterion based on information in the user profile that is reflective of the user's learning habits. The media guidance application may compare the level of exposure by retrieving a value associated with the exposure criterion (e.g., a value that specifies that the word is to be defined only six times per year) and may then compare the retrieved value to the determined level of exposure. By utilizing an exposure criterion, the media guidance application provides definitions for words that the user does not understand based on the user's learning experience, in contrast to providing definitions for words simply by virtue of a given word appearing to be difficult and thus only theoretically insufficiently understood by the user.

In some embodiments, the media guidance application may determine, based on the comparing, that the level of exposure reflects an insufficient understanding of the word. For example, if the media guidance application determines that the level of exposure (e.g., the user was exposed to the word “intransigent” five times in the past year) is less than the value of the corresponding exposure criterion (e.g., which specifies that the user needs to see the definition of the word six times during the year), the media guidance application may determine that this reflects an insufficient understanding of the word, as defined by the exposure criterion.

In some embodiments, the media guidance application may provide a definition of the word to the user, in response to determining that the level of exposure reflects an insufficient understanding of the word. The media guidance application may query a dictionary of words and generate for display on the display screen a corresponding definition of the word. For example, the media guidance application may provide the definition “characterized by refusal to comprise or to abandon an extreme position or attitude” for the word “intransigent.”

In some embodiments, the media guidance application may detect that a second word that satisfies the user-specific criterion has been encountered by the user during consumption of media by the user. For example, the media guidance application may detect the word “predilection” was spoken by the narrator of the news program.

In some embodiments, the media guidance application may determine a second level of exposure that the user has had to the second word based on an entry corresponding to the second word in the profile. For example, in the manner described above in relation to the example word “intransigent,” the media guidance application may determine the number of times the user has been exposed to the word “predilection” in the past year in order to determine the second level of exposure (e.g., the user had been exposed to the word “predilection” on ten occasions).

In some embodiments, the media guidance application may compare the second level of exposure to the exposure criterion. As previously described, the media guidance application may determine a value of an exposure criterion (e.g., eight, reflecting that the user is to be exposed to the word eight times during the year).

In some embodiments, the media guidance application may determine, based on the comparing, that the second level of exposure reflects a sufficient understanding of the second word. For example, the media guidance application may determine that the user is to have sufficient understanding of the word “predilection” because the user has been exposed to the word on ten occasions during the past year, which surpasses the value of the exposure criterion that reflects a minimum exposure for sufficient understanding (e.g., eight times during the past year).

In some embodiments, the media guidance application may monitor whether the user accessed a definition associated with the second word after the user encountered the word. The media guidance application may monitor the user's interactions with the media guidance application to optimize both the values of the exposure criterion and the user-specific criterion. The net effect of this is that the media guidance application may optimize the user's learning of new words by providing definitions for words based on the user's personal learning ability. For example, the media guidance application may determine that the user accessed a dictionary resource (e.g., www.dictionary.reference.com) in order to retrieve a definition of the word “predilection.” Such behavior is indicative of the user not fully understanding the word, in spite of the user's level of exposure to the word meeting or exceeding the value of the exposure criterion.

In some embodiments, the media guidance application, in response to detecting that the user accessed the definition associated with the second word, may modify at least one of the value of the user-specific criterion and the value for the exposure criterion. In such a way, the media guidance application accounts for manifestations of the user's learning deficiencies, and the media guidance application efficiently adapts to the user's learning habits. For example, the media guidance application may increase the value of the exposure criterion, thereby increasing the number of instances of a word that the user is to be exposed to before the media guidance application considers that a user sufficiently understands a given word.

In some embodiments, the media guidance application may determine a pause, when providing the definition of the word to the user, where the pause duration is determined by decreasing a default pause duration when the level of exposure meets or exceeds a predefined threshold, and increasing the default pause duration when the level of exposure does not meet or exceed the predefined threshold. When the media guidance application provides a definition to a user, the user may not effectively comprehend the definition unless the media guidance application pauses the media in order to allow the user to focus on understanding the meaning of the definition. While a pause may be necessary to ensure the user understands the definition, frequent pauses may be disruptive to the user's viewing or listening experience. Thus, the media guidance application may determine whether the level of exposure meets or exceed a predefined threshold. For example, the media guidance application may determine that the user has been exposed to the word “predilection” eight times, and that the predetermined threshold indicates that once the user has been exposed to the word five times, the duration of the pause is to be decreased from a default amount of three seconds to one second. Because the user may not require as much time to read and absorb the definition on the sixth or subsequent time, the media guidance application ensures that interruptions of the user's media consumption experience are minimized.

In some embodiments, the media guidance application may pause the media, while providing the definition of the word to the user, for a duration of time based on the determined pause duration. For example, as discussed above, the media guidance application may determine that the media is to be paused for one second while the user reviews the definition of the word “predilection.”

In some embodiments, the media guidance application may monitor, using the profile of the user, a web history of the user, where the web history consists of hyperlinks. For example, the media guidance application may monitor the user's web history, stored in a data file associated with a browser to identify documents (e.g., a web page describing a news event) referenced by hyperlinks in the history. The media guidance application may then retrieve each document.

In some embodiments, the media guidance application may determine an exposure of the user to a word present in a document referenced by a hyperlink of the web history. In one example, the media guidance application may analyze a document to determine a list of words used in the document.

In some embodiments, the media guidance application, in response to the determining the exposure of the user, may update the level of exposure that the user has had to the word based on the exposure of the user to the word present in a document. For example, should the media guidance application determine that the document (e.g., a web page describing a news event) contains the word “intransigent,” the media guidance application may update the corresponding entry for the word “intransigent” in the history of words stored in the profile of the user. In such a way, the media guidance application may account for the fact that the user may be exposed to words at times not associated with media consumption. Such exposure increases the user's understanding of a given word, and by accounting for it, the media guidance application ensures that a definition of the word is not provided if the user understands the word sufficiently based on the web exposure.

In some embodiments, the media guidance application may receive, in response to providing the definition of the word to the user, an indication from the user that the user had understood the meaning of the word before the definition of the word was provided to the user. The media guidance application may further adapt to the user's learning habits and progress by considering feedback from the user. For example, the media guidance application may receive an indication from the user that the user had understood the definition for the word “intransigent.”

In some embodiments, the media guidance application, in response to receiving the indication from the user, may decrease the number of definitions of words provided to the user for words that the user sufficiently understands, by modifying at least one of the value of the user-specific criterion and the value of the exposure criterion. For example, the media guidance application may decrease the value of the exposure criterion for the word “intransigent” from eight to six, as the media guidance application has received feedback from the user indicating that the user already sufficiently understands the word, in spite of the fact that the level of exposure is below the value of the exposure criterion. In effect, the media guidance application will decrease the number of definitions to the user so that the user's media consumption experience is improved.

In some embodiments, the media guidance application may receive, in response to providing the definition of the word to the user, an indication from the user that the user did not understand the meaning of the word after the definition was provided to the user. For example, the media guidance application may provide the definition (e.g., “characterized by refusal to comprise or to abandon an extreme position or attitude”) of the word “intransigent” to the user because the user's level of exposure reflects an insufficient level of understanding of the word. The media guidance application may then receive feedback from the user indicating that the user does not understand the definition of the word.

In some embodiments, the media guidance application, in response to receiving the indication from the user, may retrieve an expanded definition of the word, where the expanded definition contains further information for allowing the user to increase his or her understanding of the word. For example, when the media guidance application receives an indication from the user indicating that the user did not understand the definition of the word “intransigent,” the media guidance application may expand the definition by including a list of adjectives (e.g., “refusing compromise; uncompromising; inflexible; irreconcilable”). In such a way, the user is able to quickly and effortlessly ascertain a more comprehensive definition of the word and return to the consumption of media.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display that may be used to provide a definition for a word, in accordance with some embodiments of the disclosure;

FIG. 2 shows an another illustrative example display that may be used to provide a definition for a word, in accordance with some embodiments of the disclosure;

FIG. 3 shows an illustrative example of a display that may be used to receive user inputs for setting word definition preferences, in accordance with some embodiments of the disclosure;

FIG. 4 shows an illustrative embodiment of a display screen that may be used to provide media guidance application listings and other media guidance information, in accordance with some embodiments of the disclosure;

FIG. 5 shows another illustrative embodiment of a display screen that may be used to provide media guidance application listings, in accordance with some embodiments of the disclosure;

FIG. 6 is a block diagram of an illustrative user equipment (UE) device in accordance with some embodiments of the disclosure;

FIG. 7 is a block diagram of an illustrative media system in accordance with some embodiments of the disclosure;

FIG. 8 is a flowchart of an illustrative process for providing a definition of a word to the user in accordance with some embodiments of the disclosure;

FIG. 9 is a flowchart of an illustrative process for comparing the level of exposure to an exposure criterion, in accordance with some embodiments of the disclosure; and

FIG. 10 is a flowchart of an illustrative process for providing a definition of an idiom, in accordance with some embodiments of the disclosure.

### DETAILED DESCRIPTION

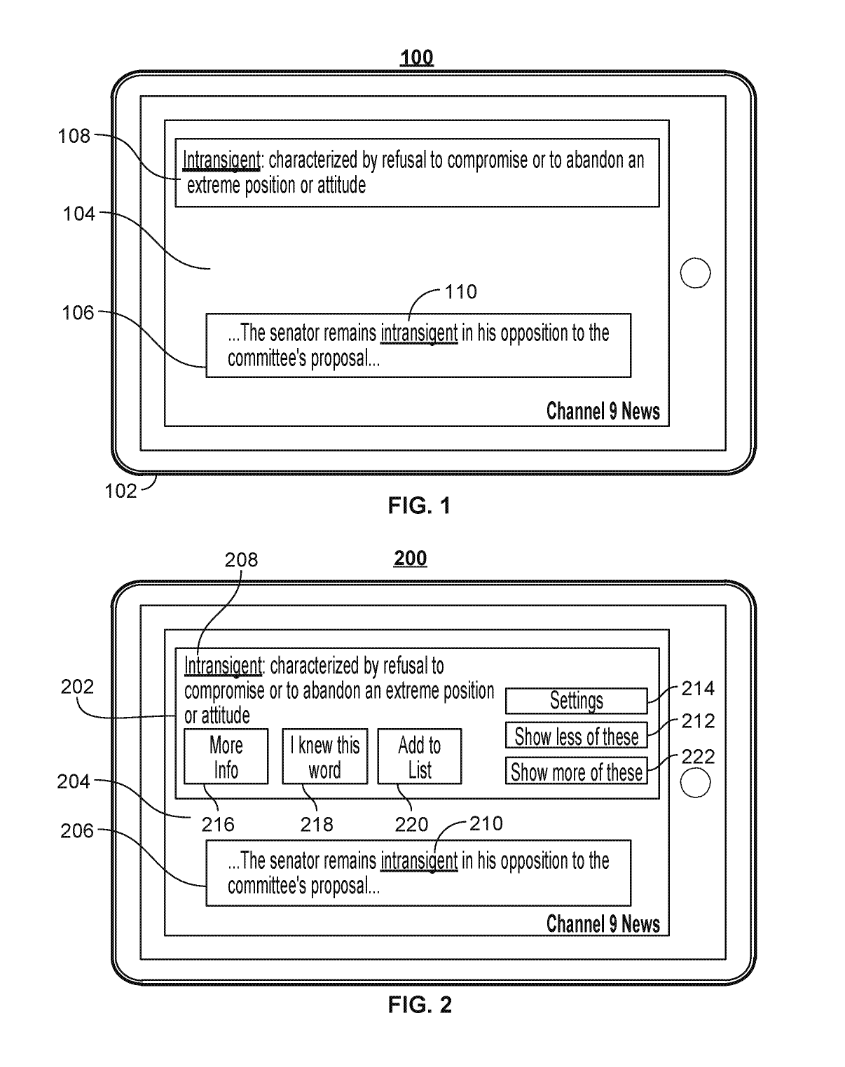

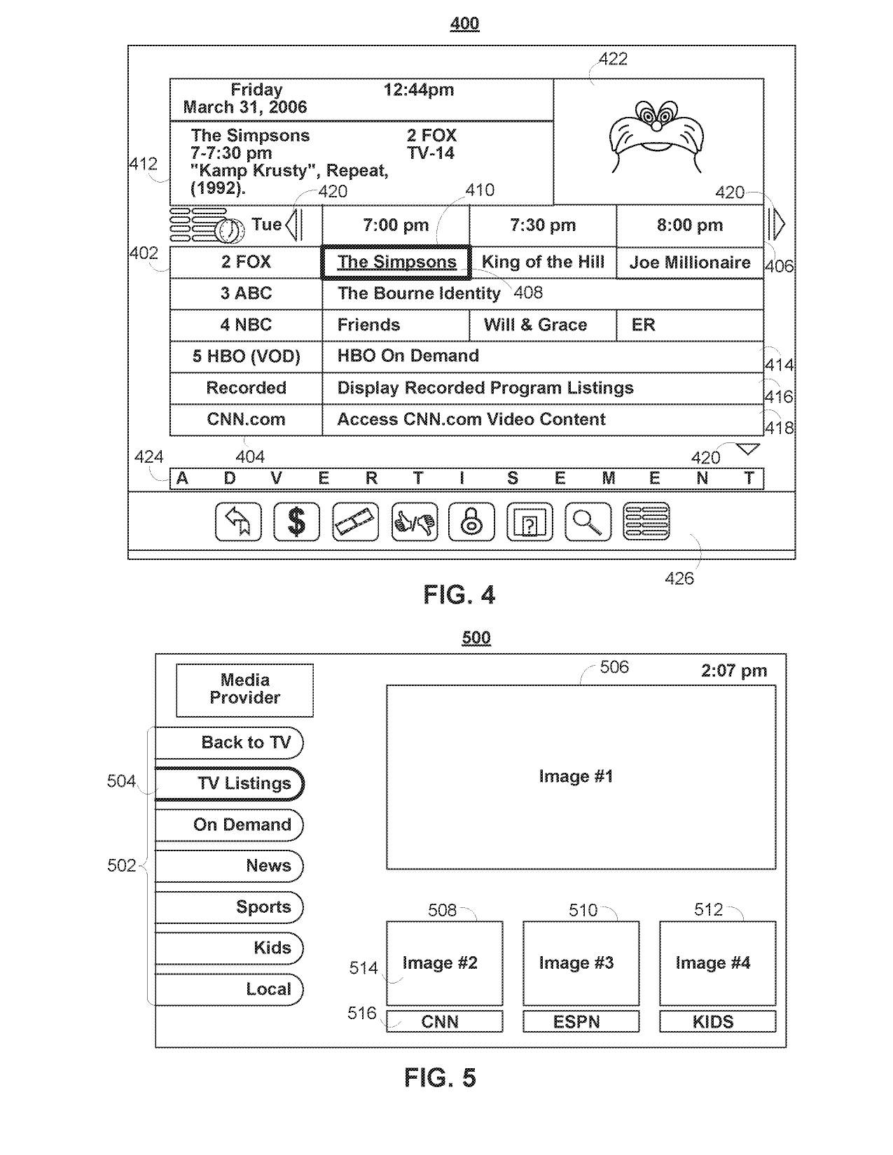

FIG. 1 depicts an illustrative example of a display that may be used to provide a definition for a word, in accordance with some embodiments of the disclosure. FIG. 1 depicts user equipment 100. User equipment 100 may have control circuitry installed thereon, which may execute a media guidance application. While FIG. 1 depicts a display screen 104 of user equipment 100, user equipment 100 may generate for display images that may be displayed on other user equipment. The functionality of user equipment, control circuitry, and the media guidance application is explained in further detail with respect to FIGS. 4-7 below.

In some embodiments, the media guidance application of user equipment 100 may access the profile of the user. The profile of the user may contain the media consumption history of the user, the user's web history, as well as a directory of words, with each word in the directory of words corresponding to a word that the user had encountered during media consumption. In addition, the media guidance may correlate each word to a history of the user's exposure to the word. The profile may also contain user-specific criteria for words and idioms, and exposure criteria that specify the frequency with which the user is to be exposed to certain words in order to sufficiently understand those words. The media guidance application may store the profile in storage of user equipment 100, or alternatively, the media guidance application may connect, via a communications network, to a remote server in order to access the user profile. Communications networks will be described in further detail in relation to FIG. 7.

In some embodiments of the disclosure, the media guidance application may determine that a word that satisfies a user-specific criterion has been encountered by the user during consumption of media by the user. For example, the media guidance application determines that word 110 (e.g., “intransigent,” having twelve characters) satisfies a user-specific criterion. The term “user-specific criterion,” as referred to herein, should be understood to mean any data that defines the technical characteristics of words for which media guidance application is to provide definitions. Effectively, the user-specific criterion limits the number of word definitions that the media guidance application provides to the user by distinguishing between words the user already understands, and those words which the user is likely not to sufficiently understand, based on characteristics of these words, such as word length (expressed in characters), level of obscurity, language, and correspondence to a list of words associated with a topic. These and other user-specific criteria will be discussed in further detail below. The media guidance application may access the profile of the user to retrieve a user-specific criterion. For example, upon powering on user equipment 100, the media guidance application may retrieve a set of user-specific criteria from a user profile stored in the storage of user equipment 100. An example user-specific criterion may indicate that the media guidance application is to provide definitions of words having twelve or more characters. The net effect of this is that the media guidance application optimizes the user's learning process by only providing definitions (and thereby interrupting the user's media consumption experience) in situations when the user is most likely to insufficiently understand a given word.

Media consumed by the user may include video (e.g., movies, television programs, videoconference calls, etc.), audio (e.g., radio programs, music, audio books, phone calls, etc.) and written media (e.g., articles on the internet, electronic books, documents, e-mail, etc.). For example, the media guidance application may detect, during playback of a video (e.g., a news program) on user equipment 100, that word 110 (e.g., “intransigent”) was spoken by a commentator. The media guidance application may detect the word using various methods. For example, when the user is viewing a video asset, the media guidance application may analyze closed caption data transmitted with the video in order to detect word 110. The closed captions corresponding to closed caption data may be displayed in the closed captions region 106. In addition to using closed caption data, the media guidance application may utilize subtitles, transcripts, and other relevant textual data. If the video is not associated with closed caption data, the media guidance application may utilize a voice recognition interface to detect words in the video. The media guidance application may also utilize other types of data, such as real-time processing of spoken words in order to detect word 110. Methods for determining conceptual boundaries in media, which can be applied to detecting words and idioms in the media, are described in detail in Rajasekharan et al. U.S. patent application Ser. No. 14/728,702, filed Jun. 2, 2015, which is hereby incorporated by reference herein in its entirety.

In some embodiments, the media guidance application may analyze relevant textual data, such as closed captions, subtitles, and transcripts, prior to the user's consumption of the media. For example, when the user selects a video-on-demand media asset for playback, the media guidance application may scan the closed caption data associated with the video-on-demand to determine a set of words for which to provide definitions for, in accordance with the methods that are described in detail below. By determining this set of words ahead of the media playback, the media guidance application may optimize the timing between the definitions that the media guidance application provides, such as to avoid overwhelming the user with a large number of definitions in a short period of time.

In some embodiments, the media guidance application may recognize text in the frame of a video watched by the user, using optical character recognition or similar methods, in order to detect words in the media. For example, the media guidance application may analyze a frame of a video using optical character recognition and determine that the frame contains the word “charcuterie” (e.g., when the word “charcuterie” appears in a frame depicting a storefront of a French butcher's shop). In such cases, the media guidance application may subsequently provide a definition of the word in close proximity to the detected word (e.g., “charcuterie”). Alternatively, the media guidance application may edit the frame of the video to remove the word and replace the word with a definition or translated equivalent. For example, the media guidance application may edit the frame to remove the text corresponding to “charcuterie” and replace it with the definition, “butcher shop,” on the screen. In such a way, the definition of the word “charcuterie” is provided without interrupting the viewing experience. Detailed examples of providing definitions of words are described below.

In the case that the user is consuming an audio asset, the media guidance application may, in addition to using a voice recognition interface as described above, connect to a media guidance data source using a communications network. The media guidance data source and communication network will be further described in relation to FIG. 7. The media guidance data source may include song lyrics and audio transcripts, which the media guidance application may utilize to detect words in the audio asset.

When the user is consuming written media, the media guidance application may analyze the data directly corresponding to the written media asset. For example, if the user is reading an electronic book, the media guidance application may determine the page number displayed on display screen 104, and identify words that correspond to the page by analyzing the data file of the electronic book.

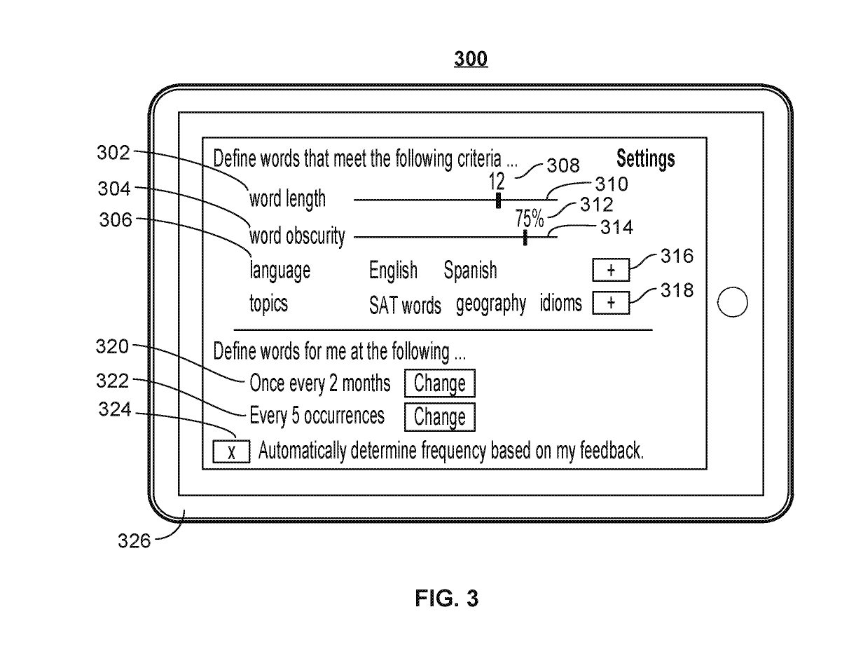

In some embodiments, the media guidance application may receive a user-defined value for the user-specific criterion. For example, the media guidance application may generate for display an option (e.g., an option to specify a minimum number of characters for a word) on display screen 104 and may subsequently receive an input from the user, using a keyboard, that specifies the minimum number of characters that a word is to have in order for the media guidance application to provide definition 108 of word 110 to the user. Other examples of user-defined values for the user-specific criterion will be discussed in relation to FIG. 3.

In some embodiments, the media guidance application may receive a user input, by way of a user input device of user equipment 100, specifying that the media guidance application is to provide definitions of words having a certain minimum length (e.g., twelve characters or more). In this way, the media guidance application may only provide definitions of words that satisfy the user criteria, without burdening the user with definitions of words that the user likely already sufficiently understands.

The media guidance application may evaluate multiple user-specific criteria concurrently. For example, when media guidance application detects the word “intransigent,” the media guidance application may evaluate a first user-specific criterion, specifying that a word should be at least fourteen characters long. Because the word is less than fourteen characters long, the media guidance application detects that the word does not satisfy the first user-specific criterion. However, the media guidance application may also evaluate a second user-specific criterion, specifying that a word that belongs to a list of words relevant for a college entrance exam should be defined for the user. When the media guidance application detects word 110 (e.g., “intransigent”) belongs to such a list of words, the media guidance application may determine that the word specifies a second user-specific criterion.

In some embodiments, the media guidance application may update the value of the user-specific criterion with the user-defined value, where detecting that the word that satisfies the user-specific criterion has been encountered by the user during consumption of media by the user includes determining that the word has a length that equals or exceeds the minimum word length. For example, the media guidance application may store, in a storage component of user equipment 100, the user-specific criterion. When the media guidance application begins playing media, the media guidance application may query the storage to determine the user-specific criterion. When word 110 (e.g., “intransigent”) in the media equals or exceeds the minimum word length (e.g., twelve characters) corresponding to the value of the user-specific criterion, the media guidance application may then provide definition 108 of word 110 to the user, assuming that the user's level of exposure to word 110 reflects an insufficient level of understanding of word 110, as will be described in greater detail below.

While the media guidance application may receive a user input specifying the user-specific criterion, as will be further discussed in relation to FIG. 3, a given media asset may contain a large number of words satisfying the user-specific criterion, to the point that the provided definitions interfere with the user's viewing experience. For example, when a user sets a user-specific criterion to a less encompassing value (e.g., a minimum word length of six characters), the media guidance application may provide a large number of definitions when the user is viewing a science program, in which the narrator uses many words that satisfy the criterion (e.g., words of six characters of more). However, when the media consumed by the user contains less difficult language, the media guidance application may lower the user-specific criterion to a more encompassing value, such that the media guidance application provides the user with all definitions that the user may wish to view. Thus, the media guidance application may determine the value of the user-specific criterion based on the types of words present in the language of the media consumed by the user, so that both the user's learning experience and media consumption experience is optimized.

Accordingly, in some embodiments, the media guidance application may store, in the profile, a history of words encountered by the user during media consumption, where the history comprises each encountered word, and where a given word of the history of words corresponds to a characteristic value that conveys a likelihood that the user may insufficiently understand the given word. The term “characteristic value,” as used herein, refers to a measure that is indicative of a quality of a word, such as word length, which is expressed in a number of characters. For example, the media guidance application may monitor the user's consumption of movies, television programming, music, and radio. The media guidance application may detect word 110 (e.g., “intransigent”), using the above-described methods of detection, in the media being consumed by the user at a given point in time. The media guidance application may then update the history of words, which the media guidance application may store in storage of user equipment 100, to indicate that the user has encountered a new instance of word 110. The media guidance application may also store the name and source of the media corresponding to the word; for example, the media guidance application may associate the word “intransigent” with the corresponding program (e.g., “Channel 9 News”) and channel (e.g., “Channel ABC”). The media guidance application may also store a timestamp in association with the word. By storing information, such as media name and channel, associated with word 110, the media guidance application may subsequently use that information in determining whether a user's exposure to the word satisfies an exposure criterion, as will be further described below. Further, the media guidance application may associate each word stored in the history with a characteristic value (e.g., word length). In this example, the media guidance application associates word 110 (e.g., “intransigent”) with the number twelve (i.e., the number of characters in the word). Based on the characteristic value, the media guidance application may determine whether a given word is unlikely to be sufficiently understood by the user without the overhead of computing the characteristic value in subsequent operations.

In some embodiments, the media guidance application may compute a mean characteristic value for a set of words of the history of words. For example, the media guidance application may query a set of the history of words and determine that a mean characteristic value (e.g., the word length) is seven (e.g., seven characters).

In some embodiments, the media guidance application may compute a standard deviation of the characteristic value for the set of words of the history of words. The media guidance application may calculate, based on querying the set of the history of words, the standard deviation of the characteristic value of the set of words. For example, the media guidance application may determine that the standard deviation of the set of words is two characters. In other words, in this particular example and based on the mean characteristic value of seven, the majority of words encountered by the user have a length between five and nine characters.

In some embodiments, the media guidance application may compute a recommended value based on the mean characteristic value and the standard deviation of the characteristic value. The net effect of this calculation is that the media guidance application may effectively determine that a word may be insufficiently understood by the user if the word belongs to a set of the longest words and therefore the words that are most likely to be difficult for the user to understand. For example, the media guidance application may multiply the standard deviation of the characteristic value by two and then may add the resultant product to the mean characteristic value. In other words, by the mathematical definition of standard deviation, the media guidance application may effectively determine a minimum number of characters for the user-specific criterion, such that the media guidance application defines only 2.3% of the most difficult words appearing in the media asset (e.g., words that are eleven or more characters in length). In such a way, the media guidance application only interrupts the user with definitions of the most difficult words that the user is very likely not to understand, so that the user can otherwise enjoy an uninterrupted media consumption experience.

In addition to providing definitions of individual words, the media guidance application may provide definitions of idioms to the user. Because idioms consist of specific words that follow a specific word order, the media guidance application may use a user-specific criterion tailored for detecting idioms. Additionally, the media guidance application may utilize the user-specific criterion to define words that meet the user's preference. Accordingly, in some embodiments, the media guidance application may detect a sequence of words. For example, the media guidance application may detect a sequence of words “burning the midnight oil,” which corresponds to the idiom “burn the midnight oil.”

The media guidance application may detect the sequence of words based on certain keywords that are characteristic of idioms. For example, the media guidance application may detect sequences of words that likely correspond to idioms by monitoring for trigger words. A “trigger word,” as used herein, refers to any word or words that are representative of an entire idiom. For example, the media guidance application may store the trigger word “midnight” in an idiom dictionary and reference the corresponding idiom “burn the midnight oil,” and, upon detecting that the trigger word “midnight” appears in the media, the media guidance application may detect other words appearing in close proximity of the word “midnight,” such as “the,” “midnight,” and “oil.”

When detecting the sequence of words, the media guidance application may limit the number of words in the sequence by determining the number of words in the idiom. For example, the media guidance application may detect the word “midnight,” and subsequently determine that the media may be referring to the idiom “burn the midnight oil.” The media guidance application may then count the number of words appearing in the idiom (e.g., four words). Thus, the media guidance application may detect three additional words in order to complete the sequence (e.g., “the midnight oil”).

In some embodiments, the media guidance application may compare the sequence of words to a plurality of idiom templates consisting of terms, where each term of an idiom template is associated with a template position. For example, the media guidance application may compare the sequence “burning the midnight oil” to idiom templates stored in an idiom dictionary. The term “idiom template,” as used herein, includes a set of words that are representative of an idiom, as will be further described below. Additionally, an idiom template may correspond to an idiom definition and the official form of the idiom. For example, the media guidance application may compare the sequence “burning the midnight oil” to idiom templates stored in a dictionary of idiom templates. Methods for identifying strings of words based on templates, which can be applied by the media guidance application to detect idioms using idiom templates, are described in detail in Venkataraman et al. U.S. patent application Ser. No. 15/055,868, filed Feb. 29, 2016, which is hereby incorporated by reference herein in its entirety. Media guidance application may connect to a remote server using a communications network in order to identify idiom templates. Idioms may be slightly altered in colloquial speech, and may take on a number of forms that stray from an official form. Additionally, idioms are frequently misspoken. Thus, in order to ensure that media guidance application successfully identifies an idiom appearing in a sequence of words, the media guidance application may utilize idiom templates that only contain the most characteristic words appearing in an idiom. In other words, terms such as articles and prepositions may be absent from the idiom template. In a similar manner, the media guidance application may process the word sequence to also remove such types of keywords (e.g., the word sequence “burning the midnight oil” becomes “burning midnight oil”)

In some embodiments, the media guidance application may determine an association metric relating to a similarity between the word sequence and the idiom template. The media guidance application may compute a string distance metric between the word sequence (e.g., “burning midnight oil”) and the idiom template (e.g., “burn midnight oil”) to determine whether the idiom corresponding to the idiom template is embedded in the sequence of words. In one example, the media guidance application may determine that the word sequence and the idiom template share two words that are common to both queries. The media guidance application may then set the association metric to the result of the calculation of dividing the number of words common to both word sequence and idiom template by the number of words contained in the idiom template. For example, the media guidance application may determine that the idiom template contains three words. The media guidance application may then set the association metric to the result of dividing the number of words common to both the idiom template and word sequence (e.g., two words) by the number of words in the idiom template (e.g., three words). In this example, the result of the calculation the media guidance application may set the association metric to the calculated value (e.g., 0.67).

In a different example, the media guidance application may determine an association metric relating to a similarity between a different word sequence (e.g., “burning man festival”) and the idiom template (e.g., “burning midnight oil”) sequence of words. In this example, the media guidance application may determine that the result of the above-described calculation is 0, because not a single word matched between the sequence of words and the idiom template. Therefore, the media guidance application may determine that in spite of the trigger word “burning,” the word sequence does not relate to an idiom and can be ignored.

A significant association metric may be indicative of the presence of an idiom embedded in the sequence of words. Any form of logic or fuzzy logic may be used to compare the word sequence to the idiom template and to determine a measure of similarity between the word sequence and idiom template.

In some embodiments, the media guidance application may determine whether the association metric meets or exceeds a similarity threshold. For example, the media guidance application may retrieve a similarity threshold stored in a storage device, and compare the threshold to the association metric. The media guidance application may determine a similarity threshold in a number of ways. The threshold may be based on the output of a function, the inputs of which may include the number of terms in the idiom template, the number of words in the word sequence, the number of variations of the idiom, and the measure of significance of each term in the idiom template. The media guidance application may then store the similarity threshold in storage. Additionally, the media guidance application may associate the similarity threshold with the user by storing the similarity threshold in a profile associated with the user.

In some embodiments, in response to determining that the association metric meets or exceeds the similarity threshold, the media guidance application provides, to the user, the idiom associated with the idiom template and an idiom definition associated with the idiom template. For example, when the media guidance application determines that the value of the association metric (e.g., 0.67) exceeds the value of the similarity threshold (e.g., 0.5), the media guidance application may present the idiom (e.g., “burn the midnight oil”) and an idiom definition (e.g., “read, study, or work late into the night”).

In some embodiments, the media guidance application may determine that an idiom associated with the idiom template is frequently misstated in media. For example, the media guidance application may determine, by comparing the idiom template (e.g., “pique interest”) associated with an idiom (e.g., “pique one's interest”) with sequences of words appearing in media, that the idiom may frequently be misstated. By calculating the association metric as previously described, the media guidance application may determine that the word sequences such as “peek one's interest,” “peak one's interest,” and “peak one's curiosity” are all related to the same idiom.

Accordingly, in some embodiments, the media guidance application may decrease the similarity threshold in response to the determining that the idiom associated with the idiom template is frequently misstated in media. For example, the media guidance application may decrease the similarity threshold to account for a high number of variations in which idioms may be presented in the media. In one example, the media guidance application may decrease the similarity threshold to a new value (e.g., 0.50) in order to properly detect word sequences that contain a highly variable idiom (e.g., “pique one's interest”).

In some embodiments, the media guidance application may provide, in addition or instead of the definition of the idiom, a list of common variations of the idiom. For example, when providing the definition of the idiom “never bite the hand that feeds you,” the media guidance application may provide a variation of the idiom (e.g., “do not bite the hand that feeds you”).

In some embodiments, the media guidance application may determine a level of exposure that the user has had to the word based on an entry corresponding to the word in the profile. The term “level of exposure,” as used herein, should be understood to be a measure of the number of instances in which the user had been exposed to a given word. For example, the media guidance application, upon detecting word 110 (e.g., “intransigent”), may search the profile to determine whether the user had been exposed to word 110 on a previous occasion. For example, the media guidance application may determine that the user had been exposed to word 110 (e.g., “intransigent”) five times in the past year. Thus, the media guidance application may set the level of exposure corresponding to word 110 to five.

In some embodiments, the media guidance application may compare the level of exposure to an exposure criterion. The term “exposure criterion,” as used herein, should be understood to mean a measure of how frequently a user is to be exposed to a given word in order to sufficiently learn and retain understanding of the definition of the word. As will be described further below, the media guidance application may receive a user input selecting a value for the exposure criteria. The media guidance may alternatively calculate an appropriate exposure criterion based on information in the user profile that is reflective of the user's learning habits. The media guidance application may compare the level of exposure by retrieving a value associated with the exposure criterion (e.g., a value that specifies that word 110 is to be defined only six times per year) and may then compare the retrieved value to the determined level of exposure. By utilizing an exposure criterion, the media guidance application provides definitions for words that the user does not understand based on the user's learning experience, in contrast to providing definitions for words simply by virtue of a word appearing to be difficult and thus only theoretically insufficiently understood by the user.

The media guidance application may specify the exposure criterion in various manners. For example, the media guidance application may maintain an exposure criterion that determines the number of times a user is to be exposed to a given word in a given interval of time. The interval of time can be set by the user. For example, the user may wish to see definition 108 for word 110 five times in a given year. In another example, the user may wish to see definition 108 of word 110 five times every quarter. In a different example, the media guidance application may not set the duration for a given exposure criterion, indicating that if the user meets the value of the exposure criterion (e.g., five times), the user will never require to see definitions of the word in order to sufficiently understand it. The media guidance application may further customize the exposure criterion. For example, the exposure criterion may be separately configured for video assets and for written media. In fact, the media guidance application may create complex exposure criteria, which may consider the exposure in each type of media (i.e., video, audio, written) individually, or simultaneously. The exposure criterion may be separately customized for words having specific characteristics. For example, a first exposure criterion may apply to words having eight characters in length; a second exposure criterion may apply to words having nine characters in length. In such a way, the media guidance application may optimize the manner in which the user learns new words. Specifically, setting lower values for exposure criteria associated with shorter words may limit the number of definitions shown for those words, which are likely to be easier for the user to understand and learn than longer words, which may require more exposure before the user sufficiently understands them.

In some embodiments, the media guidance application may determine, based on the comparing, that the level of exposure reflects an insufficient understanding of the word. For example, if the media guidance application determines that the level of exposure (e.g., the user was exposed to word 110, e.g., “intransigent,” five times in the past year) is less than the value of the corresponding exposure criterion (e.g., which specifies that the user needs to see definition 108 of word 110, e.g., “intransigent” six times during the year), the media guidance application may determine that this reflects an insufficient understanding of the word, as defined by the exposure criterion

In some embodiments, the media guidance application may provide a definition of the word to the user, in response to determining that the level of exposure reflects an insufficient understanding of the word. The media guidance application may query a dictionary of words, stored in storage of user equipment 100 or in a remote server accessible via communications network (e.g., www.dictionary.reference.com) and generate for display on display screen 104 a corresponding definition of the word. For example, the media guidance application may provide definition 108 “characterized by refusal to comprise or to abandon an extreme position or attitude” for word 110 (e.g., “intransigent”).

In some embodiments, the media guidance application may transmit the definition of the word to another user equipment device. For example, if the media guidance application is displaying a video on the display of user equipment 100, the media guidance application may utilize a communications network in order to transmit and generate for display the definition of the word on user computer equipment (e.g., a mobile telephone), such that the user can continue watching the video program without the definition obstructing the image of the video.

When the user is consuming audio, the media guidance application may pause the audio and use a text-to-speech interface to play the audio corresponding to the definition to the user. Should the audio correspond to real-time audio (e.g., a real-time radio broadcast), the media guidance application may lower the volume of the real-time audio while concurrently playing the definition of the word, such that the user may selectively focus on either the definition or the audio. Finally, should the user be consuming written media, such as an article on the internet, the media guidance application may generate for display the definition on display screen 104 of user equipment 100. In some cases, the media guidance application may position the definition of the word to be in close proximity of the word that appears in the written media.

In some embodiments, the media guidance application may detect that a second word that satisfies the user-specific criterion has been encountered by the user during consumption of media by the user. For example, the media guidance application may detect the word “predilection” was spoken by the narrator of the news program. The media guidance application may utilize the above-described methods to detect the second word.

In some embodiments, the media guidance application may determine a second level of exposure that the user has had to the second word based on an entry corresponding to the second word in the profile. For example, as described above in relation to the example word “intransigent,” the media guidance application may determine the number of times the user has been exposed to the word “predilection” in the past year in order to determine the second level of exposure (e.g., the user had been exposed to the word “predilection” on ten occasions).

In some embodiments, the media guidance application may compare the second level of exposure to the exposure criterion. As previously described, the media guidance application may determine a value of an exposure criterion (e.g., eight, reflecting that the user is to be exposed to the word eight times during the year).

In some embodiments, the media guidance application may determine, based on the comparing, that the second level of exposure reflects a sufficient understanding of the second word. For example, the media guidance application may determine that the user is to have sufficient understanding of the word “predilection” because the user has been exposed to the word on ten occasions during the past year, which surpasses the value of the exposure criterion that reflects an exposure for sufficient understanding (e.g., eight times during the past year).

In some embodiments, the media guidance application may monitor whether the user accessed a definition associated with the second word after the user encountered the word. The media guidance application may monitor the user's interactions with the media guidance application to optimize both the values of the exposure criterion and the user-specific criterion. The net effect of this is that the media guidance application may optimize the user's learning of new words by providing definitions for words based on the user's personal learning ability. For example, the media guidance application may determine that the user accessed a dictionary resource (e.g., www.dictionary.reference.com) in order to retrieve a definition of the word “predilection.” Such behavior is indicative of the user not fully understanding the word, in spite of the user's level of exposure to the word meeting or exceeding the value of the exposure criterion.

In some embodiments, the media guidance application, in response to detecting that the user accessed the definition associated with the second word, may modify at least one of the value of the user-specific criterion and the value for the exposure criterion. In such a way, the media guidance application may account for manifestations of the user's learning deficiencies so that the media guidance application adapts to the user's learning habits. For example, the media guidance application may increase the value of the exposure criterion, thereby increasing the number of words the user is required to be exposed to before the media guidance application considers that a user sufficiently understands a given word.

In some embodiments, the media guidance application may determine a pause, when providing the definition of the word to the user, where the pause duration is determined by decreasing a default pause duration when the level of exposure meets or exceeds a predefined threshold, and increasing the default pause duration when the level of exposure does not meet or exceed the predefined threshold. When the media guidance application provides definition 108 to a user, the user may not effectively comprehend definition 108 unless the media guidance application pauses the media in order to allow the user to focus on understanding the meaning of definition 108. While a pause may be necessary to ensure the user understands definition 108, frequent pauses may be disruptive to the user's viewing experience. Thus, the media guidance application may determine whether the level of exposure meets or exceed a predefined threshold. For example, the media guidance application may determine that the user has been exposed to the word “predilection” eight times, and that the predetermined threshold indicates that once the user has been exposed to the word five times, the duration of the pause is to be decreased from a default amount of three seconds to one second. Because the user may not require as much time to read and absorb the meaning of definition 108 on the sixth or subsequent time, the media guidance application ensures that interruptions of the user's media consumption experience are minimized.

The predetermined threshold may be set in a variety of ways. For example, the media guidance application may execute a function, which takes as inputs the level of exposure of the word in order to determine the length of the pause, such that a word with a low level of exposure corresponds to a longer pause, and a word with a high level of exposure corresponds to a shorter pause. The media guidance application may set multiple thresholds. When media guidance application determines that the user may sufficiently understand the word, the media guidance application may set the pause duration to zero, in which case, the media guidance application may display definition 108 without pausing the media. The media guidance application may receive default pause duration from the user, or alternatively, the media guidance application may calculate the default pause duration based on the level of exposure, value of the exposure criterion, or any other measure. In some cases, instead of pausing the media, the media guidance application may instead alter the playback of the media. For example, while providing a definition of the word “predilection,” the media guidance application may play the media asset at quarter speed, so as to avoid stopping and restarting the media, which may be uncomfortable to the user. Finally, when the user is consuming audio (e.g., radio or music), the media guidance application may lower the volume of the media, instead of pausing the media, so as to allow the user to hear both the definition and the audio of the media, in order to improve the user's listening experience by avoiding a pause of the audio, which may be uncomfortable to the user's overall listening experience.

Accordingly, in some embodiments, the media guidance application may pause the media, while providing the definition of the word to the user, for a duration of time based on the determined pause duration. For example, as discussed above, the media guidance application may determine that the media is to be paused for one second while the user reviews the definition of the word “predilection.”

Accordingly, in some embodiments, the media guidance application may generate for display, on display screen 104, an option (e.g., “Press ‘A’ if you would like to see the definition of the word intransigent”) for displaying a definition of word 110. In response to receiving a user selection of this option for displaying a definition of word 110, the media guidance application may generate definition 108 on the screen. In such a way, the media guidance application may provide definition 108 to the user only in the event that the user is interested in viewing definition 108. Otherwise, the media guidance application does not provide the definition of word 110, effectively improving the user's media consumption experience by eliminating the display of undesired definitions.

FIG. 2 shows another illustrative example display screen that may be used to provide a definition for a word, in accordance with some embodiments of the disclosure. The media guidance application may display panel 202 for the user to provide feedback for definition 208, such that the media guidance application is able to optimize the operations of the system to match the user's learning abilities, as is described above and will be described in further detail below.

In some embodiments, the media guidance application may receive, in response to providing the definition of the word to the user, an indication from the user that the user did not understand the meaning of the word after the definition was provided to the user. For example, the media guidance application may provide definition 208 (e.g., “characterized by refusal to comprise or to abandon an extreme position or attitude”) of word 210 (e.g., “intransigent”) to the user because the user's level of exposure reflects an insufficient level of understanding of the word. The media guidance application may then receive feedback from the user by way of option 216 (e.g., “more info”), indicating that the user does not understand definition 208 of word 210 (e.g., “intransigent”).

In some embodiments, the media guidance application may monitor, using the profile of the user, a web history of the user, where the web history consists of hyperlinks. For example, the media guidance application may monitor the user's web history, stored in a data file associated with a browser to identify documents (e.g., web page describing a news event) referenced by hyperlinks in the web history. The media guidance application may then retrieve each document.

In some embodiments, the media guidance application may determine an exposure of the user to a word present in a document referenced by a hyperlink of the web history. In one example, the media guidance application may analyze a document to determine a list of words used in the document.

In some embodiments, the media guidance application, in response to the determining the exposure of the user, may update the level of exposure that the user has had to the word based on the exposure of the user to the word present in a document. For example, should the media guidance application determine that the document (e.g., a web page describing a news event) contains the word “intransigent,” the media guidance application may update the corresponding entry for the word “intransigent” in the history of words stored in the profile of the user. In such a way, the media guidance application may account for the fact that the user may be exposed to words at times not associated with media consumption. Such exposure increases the user's understanding of a given word, and by accounting for this exposure, the media guidance application ensures that a definition of the word is not provided if the user understands the word sufficiently, thereby improving the user's learning and media viewing experience.

In some embodiments, the media guidance application, in response to receiving the indication from the user, may retrieve an expanded definition of the word, where the expanded definition contains further information for allowing the user to increase his or her understanding of the word. For example, when the media guidance application receives an indication from the user, using option 216 (e.g., “more info”), indicating that the user did not understand the definition of word 210 (e.g., “intransigent”), the media guidance application may expand definition 208 by including a list of adjectives (e.g., “refusing compromise; uncompromising; inflexible; irreconcilable”). In such a way, the user is able to effortlessly find further information about word 210 to facilitate the user's learning process.

In some embodiments, the media guidance application may receive, in response to providing the definition of the word to the user, an indication from the user that the user had understood the meaning of the word before the definition of the word was provided to the user. The media guidance application may adapt to the user's learning habits and progress by considering feedback from the user. For example, the media guidance application may receive indication by way of a user selection of option 218 (e.g., “I knew this word) from the user, indicating that the user had understood definition 208 for word 210 (e.g., “intransigent”) by way of a user input device. This may be useful for determining that the user is improving the rate at which he or she is learning new words. For example, should the media guidance application receive multiple indications from the user indicating that the user had understood a given definition of a word before the definition was provided to the user, the media guidance application may modify the exposure criterion by decreasing the value associated with the exposure criterion in such a way that the media guidance application will consider that a user understands a given word following fewer instances of exposure, thereby limiting the definitions provided for words that the user likely already knows. Additionally or alternatively, the media guidance application may store a flag in the user profile indicating that the media guidance application should not provide definition for word 210 in the future.

In some embodiments, the media guidance application may receive an indication from the user for adding the word to a list. The media guidance application may maintain a list of words for which the media guidance application had provided definitions in the past. The media guidance application may add words to the list automatically, or alternatively, the media guidance application may receive feedback from the user via option 220 (e.g., “add to list”) to add a given word to the list. The media guidance application may then provide access to the list of words so that the user is able to review the words and augment his or her learning process.

In some embodiments, the media guidance application may provide a quiz question to the user based on a word or a definition of a word. By quizzing the user on words encountered during media consumption, the media guidance application may further increase the user's understanding of words. In one example, the media guidance application may receive user input, via user input interface of user equipment 200, selecting an option (e.g., “quiz me on words”) for quizzing the user on the definitions of one or more previously presented words. While not depicted in the figures, the media guidance application may display this quiz option in display panel 202, or alternatively, in a screen displaying the list of words. In other examples, the media guidance application may generate questions upon detecting that the user has powered on user equipment 200, or in response to detecting that the user wishes to begin consuming a particular media asset. In one example, the media guidance application may require that a user answers a number of questions correctly before the media guidance application proceeds to play back a media asset for the user. The media guidance application may maintain detailed statistics of the answered questions, which the media guidance application may utilize to generate the user's progress reports, as well as to modify the exposure criteria and user-specific criteria to reflect the user's learning progress, as previously described.

In some embodiments, the media guidance application may generate a question on the display screen in order to quiz the user on the definitions of recently provided words. For example, media guidance application may display a question (e.g., “What's the definition of the word intransigent?”) on display screen 204. The media guidance application may then provide various methods for the user to input an answer. In one example, the media guidance application may provide a multiple choice answer set, with individually-selectable answers, each answer relating to one correct definitions and a set of incorrect definitions. In other examples, the user may be able to utilize the user input interface of user equipment 200 (e.g., a touch screen) to type in the definition of the word in the question. The media guidance application may keep the content paused until the user answers a question correctly.

In some embodiments, the media guidance application may receive feedback from the user with regard to the user-specific criteria by way of options 222 (e.g., “Show less of these”), and 212 (e.g., “Show more of these”). For example, in response to receiving feedback from the user by way of option 222, the media guidance application may lower the user-specific criteria in order to increase the number of definitions that the media guidance application provides to the user. For example, the media guidance application may lower the user-specific criteria that relates to word length, such that the media guidance application defines words of a shorter length for the user.

In some embodiments, the media guidance application may receive feedback from the user, by way of a selection of option 214 (e.g., “settings”), indicating that the user wishes to interact with a display screen that may be used to receive user inputs for setting word definition preferences. Such a screen will be described in relation to FIG. 3.

FIG. 3 shows an illustrative example of a screen that may be used to receive user inputs for setting word definition preferences, in accordance with some embodiments of the disclosure. For example, the media guidance application may generate a number of options for defining user-specific criteria for words which media guidance application is to provide definitions for. Such options may include option 302 (i.e., option for setting the minimum length of a word), option 304 (i.e., option for setting the minimum level of obscurity of a word), option 306 (i.e., option for setting the language of a word), and option 308 (i.e., option for setting which topics a word is to be associated with). When the media guidance application receives input via slider 308 for option 302, the media guidance application may update the word length user-specific criterion to correspond to the number of letters selected by the user. In a different example, the media guidance application may receive feedback via slider 312, indicating that words of only a certain obscurity are to be defined. An obscurity of a word relates to how frequently the word is used in media, such that a word that is used infrequently has a high level of obscurity (e.g., 90%), and a word that is relatively common, and thus more likely to be understood by the user, has a lower level of obscurity (e.g. 20%).

The media guidance application may also receive input from the user by way of button 316 to indicate that the media guidance application is to provide definitions for words of specific languages. For example, when a user, who is a native English speaker, is consuming media, the user may not be interested in seeing definitions for English words appearing in the media. The user may, however, be interested in definitions of words of a language that the user is interested in learning, such as Spanish. Accordingly, the user may use button 316 to specify whether a word belonging to a given language is to be defined. Likewise, the user may instead be interested in seeing definitions for words that belong to specific topic groups. For example, a user, who is a high school student preparing for a college exam, may use button 318 to specify that words belonging to list of words relevant to a college entrance exam are to be defined for the user. In response, the media guidance application may provide definitions of such words, even if those words do not satisfy another user-specific criterion, such as the user-specific criterion corresponding to word length.

In some embodiments, the media guidance application may automatically determine a language value for the user-specific criterion. This is particularly useful for providing definitions when a user is viewing a media asset in the user's primary language, but that also contains dialogue in a language that the user may not understand. As referred to herein, the term “primary language of the user” refers to a language that the user considers himself or herself to be fluent in. As referred to herein, the term “primary language of a media asset” refers to a language that reflects the majority of the dialogue in a media asset. The media guidance application may query the user profile to determine the primary language or primary languages of the user. In a similar vein, the media guidance application may query a media guidance data source to determine the primary language of the media asset. For example, when a media asset originates from the United States, the media guidance may infer that the primary language of that media asset is English.

In some embodiments, the media guidance may determine that an English-speaking user (i.e., the primary language of such a user is English) is viewing a movie, the main dialogue of which is in English, and that the user may encounter snippets of dialogue that are in a different language (e.g., French). The media guidance application may detect the presence of words that are not in the user's primary language, the media guidance application may set the user-specific criterion to French, so that only words in French, which the user is unlikely to sufficiently understand, are defined for the user. The media guidance application may determine the language of each word by analyzing transcripts associated with the media, which frequently reference the language used in a particular segment of dialogue. The media guidance may also utilize a dictionary to determine whether a particular word belongs to the user's primary language.

It is important to note that the media guidance application may utilize a number of user-specific criteria concurrently so as to allow the user the opportunity to fine-tune the user's word learning experience. For example, the media guidance application may utilize all four criteria present on display screen 326. Although not depicted in FIG. 3, the media guidance application may provide the user with the opportunity to select a definition profile. A definition profile may contain a number of user-specific criteria that media guidance application may utilize concurrently, reflecting the word learning interests of various types of users. For example, a high school student may request a definition profile (e.g., words of ten or more characters, 95% obscurity, and English words only) that contains user-specific definition criteria catering to the needs of typical high school students. The media guidance application may store a number of definition profiles, which the user can select. Additionally, the media guidance application may automatically detect an optimal profile based on detecting the user consuming the media. For example, the media guidance application may determine the age of the user based on the types of shows viewed by the user. For example, the media guidance application may determine that the user frequently watches shows popular with high school students (e.g., using ratings, popularity metrics, air time, media name, media source, or any other suitable means.). Accordingly the media guidance application may automatically retrieve a relevant definition profile (e.g., a definition profile relevant to high school students) that media guidance application will utilize while the user consumes media.

The media guidance application may generate a number of options for defining exposure criteria for words for which media guidance application is to provide definitions for. Such options may include option 320 (i.e., option for setting the frequency with which a user is to see a definition for a given word in terms of time), option 322 (i.e., option for setting the frequency with which a user is to see a definition for a given word in terms of occurrences of the word), and option 324 (i.e., option for setting the frequency automatically based on the user's learning habits). For example, the media guidance application may receive input from the user indicating that the user wishes to see definitions of words satisfying the user-specific criterion once every two months, by way of option 320. In such a way, the user may regularly review the definition of the word, promoting the understanding of the word, while at the same time ensuring that the definition is not provided too frequently so as to affect the user's media consumption experience. In a different example, the media guidance application may receive user input via option 324 to indicate that a word satisfying the user-specific criteria is to be defined once every five occurrences of the word.

Although not depicted in FIG. 3, the media guidance application may provide an option for recommending media based on the user-specific criteria selected by the user. In order to achieve this, the media guidance application may track words and idioms present in the media available to the user. For example, the media guidance application may maintain a global history of words, that may contain a word entry for word 110 and a corresponding media asset name (e.g., “Channel 9 News”) in which the word appeared. The media guidance application may track the word history across multiple data sources (e.g., television channels, video-on-demand sources, radio stations, electronic books, internet sites, etc.). Further, the media guidance application may associate each entry in the history of words with a word characteristic (e.g., a word length of nine characters, the word is in French, the word belongs to a college entrance exam word list, etc.).

The media guidance application may use the above-described global word history to calculate distribution profiles for each media asset. For example, the media guidance application may determine that a first show (e.g., “The Simpsons”) contains, on average, 20 instances of words that belong to a list of college entrance exam words. The media guidance application may use various measures to calculate the distribution profiles (e.g., percentages, counts, word rate per hour, etc.). The media guidance application may also determine that a second show (e.g., “Mad Men”) contains, on average, 50 instances of words that belong to a list of college entrance exam words.

The media guidance application may generate media recommendations to the user based on the calculated distribution profiles and based on the user-specific criteria. For example, upon determining that the user has specified that words belonging to a college entrance exam word list are to be defined for the user, the media guidance application may search distribution profiles to identify shows that best meet the user's user-specific criteria needs. For example, the media guidance application may recommend the second show (e.g., “Mad Men”) to the user in response to determining that the second show contains the most instances of words, out of any available media asset, that belong to a list of college entrance exam words. The media guidance application may consider user-specific criterion in making a recommendation, such that the user is exposed to a large number of words that he or she may be interested in.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

FIGS. 4-5 show illustrative display screens that may be used to provide media guidance data. The display screens shown in FIGS. 4-5 may be implemented on any suitable user equipment device or platform. While the displays of FIGS. 4-5 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 4 shows illustrative grid of a program listings display 400 arranged by time and channel that also enables access to different types of content in a single display. Display 400 may include grid 402 with: (1) a column of channel/content type identifiers 404, where each channel/content type identifier (which is a cell in the column) identifies a different channel or content type available; and (2) a row of time identifiers 406, where each time identifier (which is a cell in the row) identifies a time block of programming. Grid 402 also includes cells of program listings, such as program listing 408, where each listing provides the title of the program provided on the listing's associated channel and time. With a user input device, a user can select program listings by moving highlight region 410. Information relating to the program listing selected by highlight region 410 may be provided in program information region 412. Region 412 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 402 may provide media guidance data for non-linear programming including on-demand listing 414, recorded content listing 416, and Internet content listing 418. A display combining media guidance data for content from different types of content sources is sometimes referred to as a “mixed-media” display. Various permutations of the types of media guidance data that may be displayed that are different than display 400 may be based on user selection or guidance application definition (e.g., a display of only recorded and broadcast listings, only on-demand and broadcast listings, etc.). As illustrated, listings 414, 416, and 418 are shown as spanning the entire time block displayed in grid 402 to indicate that selection of these listings may provide access to a display dedicated to on-demand listings, recorded listings, or Internet listings, respectively. In some embodiments, listings for these content types may be included directly in grid 402. Additional media guidance data may be displayed in response to the user selecting one of the navigational icons 420. (Pressing an arrow key on a user input device may affect the display in a similar manner as selecting navigational icons 420.)

Display 400 may also include video region 422, and options region 426. Video region 422 may allow the user to view and/or preview programs that are currently available, will be available, or were available to the user. The content of video region 422 may correspond to, or be independent from, one of the listings displayed in grid 402. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 426 may allow the user to access different types of content, media guidance application displays, and/or media guidance application features. Options region 426 may be part of display 400 (and other display screens described herein), or may be invoked by a user by selecting an on-screen option or pressing a dedicated or assignable button on a user input device. The selectable options within options region 426 may concern features related to program listings in grid 402 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), embodiments of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 7. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 5. Video mosaic display 500 includes selectable options 502 for content information organized based on content type, genre, and/or other organization criteria. In display 500, television listings option 504 is selected, thus providing listings 506, 508, 510, and 512 as broadcast program listings. In display 500 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 508 may include more than one portion, including media portion 514 and text portion 516. Media portion 514 and/or text portion 516 may be selectable to view content in full-screen or to view information related to the content displayed in media portion 514 (e.g., to view listings for the channel that the video is displayed on).

The listings in display 500 are of different sizes (i.e., listing 506 is larger than listings 508, 510, and 512), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

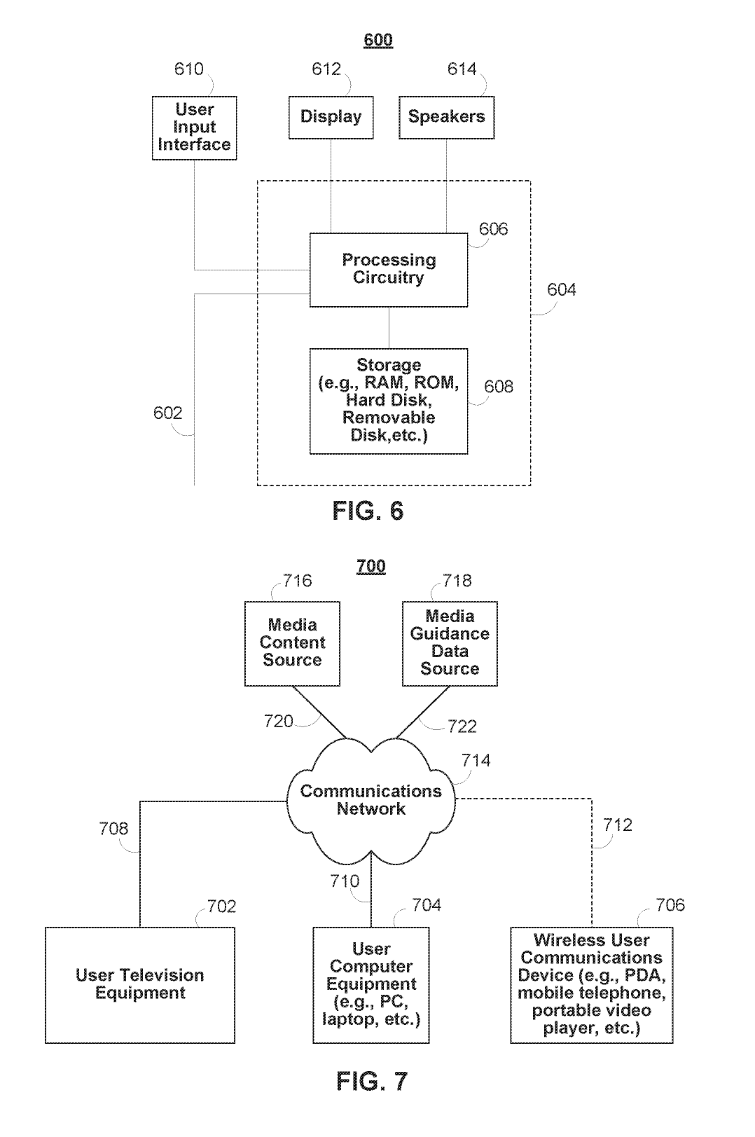

Users may access content and the media guidance application (and its display screens described above and below) from one or more of their user equipment devices. FIG. 6 shows a generalized embodiment of illustrative user equipment device 600. More specific implementations of user equipment devices are discussed below in connection with FIG. 7. User equipment device 600 may receive content and data via input/output (hereinafter “I/O”) path 602. I/O path 602 may provide content (e.g., broadcast programming, on-demand programming, Internet content, content available over a local area network (LAN) or wide area network (WAN), and/or other content) and data to control circuitry 604, which includes processing circuitry 606 and storage 608. Control circuitry 604 may be used to send and receive commands, requests, and other suitable data using I/O path 602. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing.

Control circuitry 604 may be based on any suitable processing circuitry such as processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for a media guidance application stored in memory (i.e., storage 608). Specifically, control circuitry 604 may be instructed by the media guidance application to perform the functions discussed above and below. For example, the media guidance application may provide instructions to control circuitry 604 to generate the media guidance displays. In some implementations, any action performed by control circuitry 604 may be based on instructions received from the media guidance application.

In client-server based embodiments, control circuitry 604 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 7). In addition, communications circuitry may include circuitry that enables peer-to-peer communication of user equipment devices, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as media guidance data described above. Nonvolatile memory may also be used (e.g., to launch a boot-up routine and other instructions). Cloud-based storage, described in relation to FIG. 7, may be used to supplement storage 608 or instead of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for upconverting and downconverting content into the preferred output format of the user equipment 600. Circuitry 604 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment 600, the tuning and encoding circuitry (including multiple tuners) may be associated with storage 608.

A user may send instructions to control circuitry 604 using user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of user equipment device 600. For example, display 612 may be a touchscreen or touch-sensitive display. In such circumstances, user input interface 610 may be integrated with or combined with display 612. Display 612 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 612 may be HDTV-capable. In some embodiments, display 612 may be a 3D display, and the interactive media guidance application and any suitable content may be displayed in 3D. A video card or graphics card may generate the output to the display 612. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 604. The video card may be integrated with the control circuitry 604. Speakers 614 may be provided as integrated with other elements of user equipment device 600 or may be stand-alone units. The audio component of videos and other content displayed on display 612 may be played through speakers 614. In some embodiments, the audio may be distributed to a receiver (not shown), which processes and outputs the audio via speakers 614.

The guidance application may be implemented using any suitable architecture. For example, it may be a stand-alone application wholly-implemented on user equipment device 600. In such an approach, instructions of the application are stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to generate any of the displays discussed herein. Based on the processed instructions, control circuitry 604 may determine what action to perform when input is received from input interface 610. For example, movement of a cursor on a display up/down may be indicated by the processed instructions when input interface 610 indicates that an up/down button was selected.

In some embodiments, the media guidance application is a client-server based application. Data for use by a thick or thin client implemented on user equipment device 600 is retrieved on-demand by issuing requests to a server remote to the user equipment device 600. In one example of a client-server based guidance application, control circuitry 604 runs a web browser that interprets web pages provided by a remote server. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on equipment device 600. This way, the processing of the instructions is performed remotely by the server while the resulting displays are provided locally on equipment device 600. Equipment device 600 may receive inputs from the user via input interface 610 and transmit those inputs to the remote server for processing and generating the corresponding displays. For example, equipment device 600 may transmit a communication to the remote server indicating that an up/down button was selected via input interface 610. The remote server may process instructions in accordance with that input and generate a display of the application corresponding to the input (e.g., a display that moves a cursor up/down). The generated display is then transmitted to equipment device 600 for presentation to the user.

In some embodiments, the media guidance application is downloaded and interpreted or otherwise run by an interpreter or virtual machine (run by control circuitry 604). In some embodiments, the guidance application may be encoded in the ETV Binary Interchange Format (EBIF), received by control circuitry 604 as part of a suitable feed, and interpreted by a user agent running on control circuitry 604. For example, the guidance application may be an EBIF application. In some embodiments, the guidance application may be defined by a series of JAVA-based files that are received and run by a local virtual machine or other suitable middleware executed by control circuitry 604. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 600 of FIG. 6 can be implemented in system 700 of FIG. 7 as user television equipment 702, user computer equipment 704, wireless user communications device 706, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 6 may not be classified solely as user television equipment 702, user computer equipment 704, or a wireless user communications device 706. For example, user television equipment 702 may, like some user computer equipment 704, be Internet-enabled allowing for access to Internet content, while user computer equipment 704 may, like some television equipment 702, include a tuner allowing for access to television programming. The media guidance application may have the same layout on various different types of user equipment or may be tailored to the display capabilities of the user equipment. For example, on user computer equipment 704, the guidance application may be provided as a web site accessed by a web browser. In another example, the guidance application may be scaled down for wireless user communications devices 706.

In system 700, there is typically more than one of each type of user equipment device but only one of each is shown in FIG. 7 to avoid overcomplicating the drawing. In addition, each user may utilize more than one type of user equipment device and also more than one of each type of user equipment device.

In some embodiments, a user equipment device (e.g., user television equipment 702, user computer equipment 704, and wireless user communications device 706) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 714. Namely, user television equipment 702, user computer equipment 704, and wireless user communications device 706 are coupled to communications network 714 via communications paths 708, 710, and 712, respectively. Communications network 714 may be one or more networks including the Internet, a mobile phone network, mobile voice or data network (e.g., a 4G or LTE network), cable network, public switched telephone network, or other types of communications network or combinations of communications networks. Paths 708, 710, and 712 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 712 is drawn with dotted lines to indicate that in the exemplary embodiment shown in FIG. 7 it is a wireless path and paths 708 and 710 are drawn as solid lines to indicate they are wired paths (although these paths may be wireless paths, if desired). Communications with the user equipment devices may be provided by one or more of these communications paths, but are shown as a single path in FIG. 7 to avoid overcomplicating the drawing.

Although communications paths are not drawn between user equipment devices, these devices may communicate directly with each other via communication paths, such as those described above in connection with paths 708, 710, and 712, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 714.

System 700 includes content source 716 and media guidance data source 718 coupled to communications network 714 via communication paths 720 and 722, respectively. Paths 720 and 722 may include any of the communication paths described above in connection with paths 708, 710, and 712. Communications with the content source 716 and media guidance data source 718 may be exchanged over one or more communications paths, but are shown as a single path in FIG. 7 to avoid overcomplicating the drawing. In addition, there may be more than one of each of content source 716 and media guidance data source 718, but only one of each is shown in FIG. 7 to avoid overcomplicating the drawing. (The different types of each of these sources are discussed below.) If desired, content source 716 and media guidance data source 718 may be integrated as one source device. Although communications between sources 716 and 718 with user equipment devices 702, 704, and 706 are shown as through communications network 714, in some embodiments, sources 716 and 718 may communicate directly with user equipment devices 702, 704, and 706 via communication paths (not shown) such as those described above in connection with paths 708, 710, and 712.

Content source 716 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 716 may be the originator of content (e.g., a television broadcaster, a Webcast provider, etc.) or may not be the originator of content (e.g., an on-demand content provider, an Internet provider of content of broadcast programs for downloading, etc.). Content source 716 may include cable sources, satellite providers, on-demand providers, Internet providers, over-the-top content providers, or other providers of content. Content source 716 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 718 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 718 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 718 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 718 may provide user equipment devices 702, 704, and 706 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 608, and executed by control circuitry 604 of a user equipment device 600. In some embodiments, media guidance applications may be client-server applications where only a client application resides on the user equipment device, and server application resides on a remote server. For example, media guidance applications may be implemented partially as a client application on control circuitry 604 of user equipment device 600 and partially on a remote server as a server application (e.g., media guidance data source 718) running on control circuitry of the remote server. When executed by control circuitry of the remote server (such as media guidance data source 718), the media guidance application may instruct the control circuitry to generate the guidance application displays and transmit the generated displays to the user equipment devices. The server application may instruct the control circuitry of the media guidance data source 718 to transmit data for storage on the user equipment. The client application may instruct control circuitry of the receiving user equipment to generate the guidance application displays.

Content and/or media guidance data delivered to user equipment devices 702, 704, and 706 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 700 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 7.

In one approach, user equipment devices may communicate with each other within a home network. User equipment devices can communicate with each other directly via short-range point-to-point communication schemes described above, via indirect paths through a hub or other similar device provided on a home network, or via communications network 714. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 716 to access content. Specifically, within a home, users of user television equipment 702 and user computer equipment 704 may access the media guidance application to navigate among and locate desirable content. Users may also access the media guidance application outside of the home using wireless user communications devices 706 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations that provide cloud-based services to various types of users and devices connected via a network such as the Internet via communications network 714. These cloud resources may include one or more content sources 716 and one or more media guidance data sources 718. In addition or in the alternative, the remote computing sites may include other user equipment devices, such as user television equipment 702, user computer equipment 704, and wireless user communications device 706. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 704 or wireless user communications device 706 having content capture feature. Alternatively, the user can first transfer the content to a user equipment device, such as user computer equipment 704. The user equipment device storing the content uploads the content to the cloud using a data transmission service on communications network 714. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 6.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

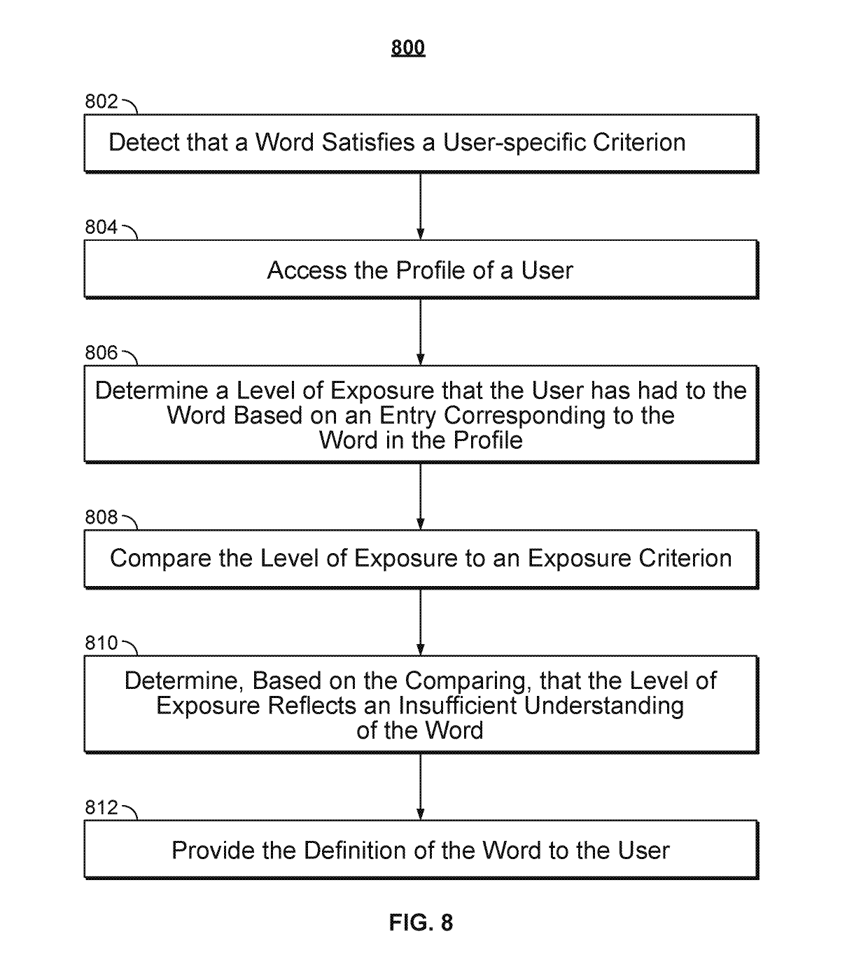

FIG. 8 is flowchart of an illustrative process for providing a definition of a word to the user in accordance with some embodiments of the disclosure. Process 800 begins at 802, where the media guidance application detects that a word satisfies a user-specific criterion. User equipment 100 may include any capability described with respect to user equipment 702, 704, and/or 706. As depicted in FIG. 1, the media guidance application detects, while generating a news program on user equipment 100, that word 110 (e.g., “intransigent”) was spoken by a commentator, and that word 110, having twelve characters, satisfies a user-specific criterion indicating that words having twelve or more characters are be defined for the user.

Process 800 then continues to 804, where the media guidance application accesses the profile of a user. The media guidance application queries storage 608 to identify data associated with the user, which is stored in a user profile. The user profile contains entries corresponding to words encountered by the user during media consumption. Each entry is associated with an encountered word, as well as a timestamp corresponding to the time at which the user encountered the word.

Process 800 then continues to 806, where the media guidance application determines a level of exposure that the user has had to the word based on an entry corresponding to the word in the profile. The media guidance application determines the exposure that the user has had to word 110 (e.g., “intransigent”) by generating a count of entries which correspond to the word. The media guidance application then determines that there are three entries corresponding to word 110.

Process 800 then continues to 808, where the media guidance application compares the level of exposure to an exposure criterion. The media guidance application compares the level of exposure determined at 806 to an exposure criterion which specifies that the user is to be exposed to definition 108 for word 110 five times in a given year.

Process 800 then continues to 810, where the media guidance application determines, based on the comparing, that the level of exposure reflects an insufficient understanding of the word. Because the level of exposure (i.e., five occurrences per year) is lower than the level of exposure (i.e., three times), the media guidance application determines that the level of exposure reflects an insufficient understanding of the word.

Process 800 then continues to 812, where the media guidance application provides the definition of the word to the user. The media guidance application generates definition 108 on display screen 104 of user equipment 100 so that the user reads the definition and increases his or her understanding of word 110 (e.g., “intransigent”).

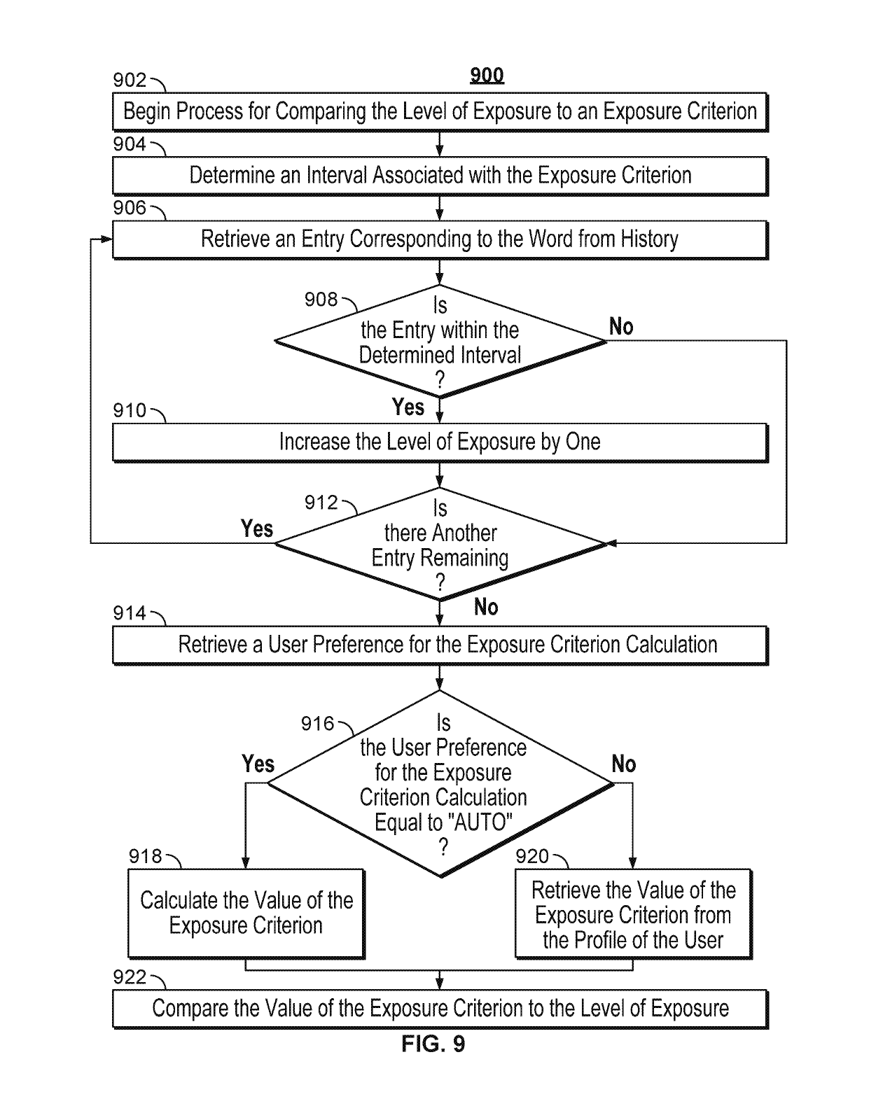

FIG. 9 is flowchart of an illustrative process for comparing the level of exposure to an exposure criterion, in accordance with some embodiments of the disclosure. Process 900 begins at 902, which corresponds to step 808 of FIG. 8. At 902, the media guidance application initializes any needed variables for process 900.

Process 900 then continues to 904, where the media guidance application determines an interval associated with the exposure criterion. Control circuitry queries storage 608 to identify the interval associated with the exposure criterion that specifies how frequently, in terms of time, the user is to be provided with a definition of word 110. Control circuitry determines that the value corresponding to the exposure criterion indicates that the user is to be exposed to word 110 five times during a year. Thus, the media guidance application determines that the interval associated with the exposure criteria is one year.

Process 900 then continues to 906, where the media guidance application retrieves an entry corresponding to the word from history. The media guidance application queries a history of words stored in the user profile that corresponds to word 110. The entry is associated with a timestamp.

Process 900 then continues to 908, where the media guidance application determines whether the entry is within the determined interval (e.g., within the past one year). Should the media guidance application determine that there is an entry having a timestamp within the determined interval, process 900 continues to 910, otherwise process 900 proceeds to 912.

At 910, the media guidance application increases the level of exposure by one in order to reflect that the user has been exposed to word 110 (e.g., “intransigent”) associated with the entry. Process 900 then proceeds to 912.

At 912, the media guidance application determines whether there is another entry corresponding to the word in the user history. If the media guidance application determines that there is another entry in the word history, process 900 returns to 906 in order to retrieve the next entry. Otherwise, process 900 proceeds to 914.

At 914, the media guidance application retrieves a user preference for the exposure criterion calculation. The media guidance application receives user input via option 324 of FIG. 3, indicating that media guidance application is to automatically calculate the exposure criterion. In this case, a flag corresponding to the user preference for the exposure criterion is set to “AUTO.”

Process 900 then continues to 916, where the media guidance application determines whether the user preference for the exposure criterion is equal to “AUTO.” Should the media guidance application determine that the user preference is set to “AUTO,” process 900 continues to 918. Otherwise, process 900 continues to 920

At 918, the media guidance application calculates the value of the exposure criterion. The media guidance application considers user feedback received via options 206, 210, and 212 when making this determination, and determines that the user is to be exposed to each word at least five times during a given year. Process 900 then continues to 922.

At 920, the media guidance application retrieves the value of the exposure criterion from the profile of the user. Process 900 then continues to 922.

At 922, the media guidance application compares the value of the exposure criterion to the level of exposure. Control circuitry 608 determines whether the exposure criterion is greater than the level of exposure for word 110 (e.g., “intransigent”).

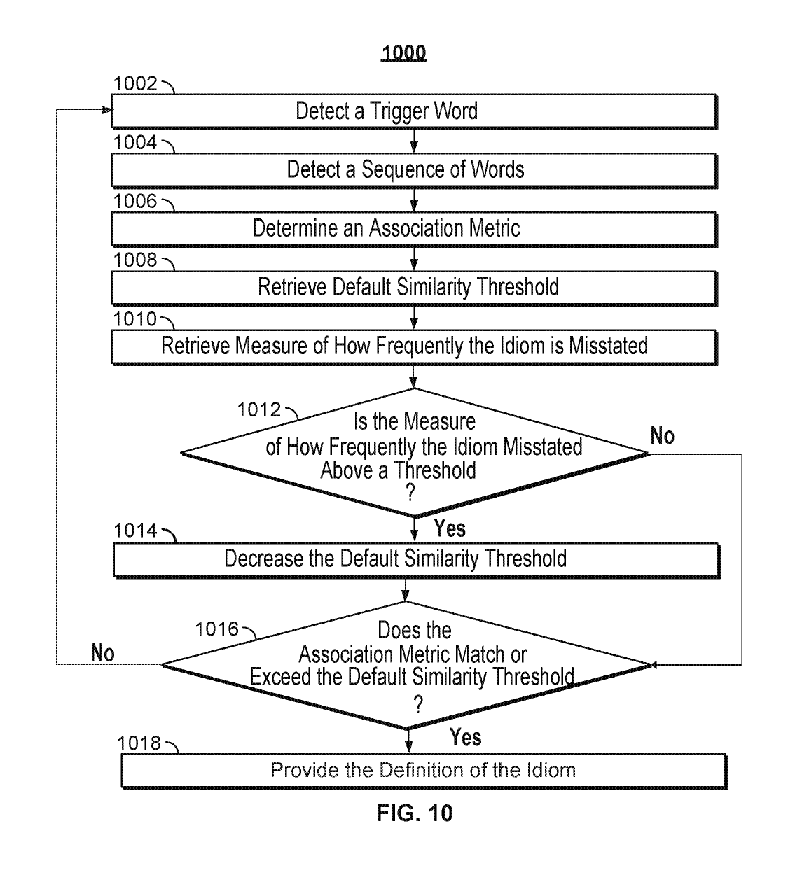

FIG. 10 is flowchart of an illustrative process for providing a definition of an idiom, in accordance with some embodiments of the disclosure. Process 1000 begins at 1002, where the media guidance application detects a trigger word in a video, by analyzing the textual data corresponding to the video. The media guidance application associates certain characteristic words as evidence that an idiom may be present in the media. When the media guidance application detects the word “midnight” in the media, the media guidance application queries storage 608 to determine that the word “midnight” is characteristic word corresponding to the idiom “burn the midnight oil.” Thus, the media guidance application detects the trigger word “midnight.”

Process 1000 then continues to 1004, where the media guidance application detects a sequence of words. The media guidance application detects a sequence of words appearing in the media, in proximity of the trigger word “midnight,” such as “burning,” “the,” and “oil.” In order to detect the sequence of words, the media guidance application counts the number of words appearing in the idiom corresponding to the trigger word “midnight.” Thus, because the idiom “burn the midnight oil” contains two words before the trigger word “midnight” and one word after the trigger word “midnight,” the media guidance application, in order to detect the sequence of words, detects two words appearing in the media before the trigger word “midnight” (e.g., “burning” and “the”), and one word after the trigger word “midnight” (e.g., “oil”).

Process 1000 then continues to 1006, where the media guidance application determines an association metric between the idiom template and the sequence of words. The media guidance application processes the word sequence to remove keywords of low significance, such as articles (e.g., “the”) and prepositions (e.g., “of”), thus the media guidance application processes “burning the midnight oil” to “burn midnight oil.” The media guidance application then retrieves the idiom template corresponding to the idiom (e.g., “burn midnight oil”). The media guidance application determines that the processed word sequence and the idiom template share two words that are common to both queries (e.g., “midnight,” and “oil”). The media guidance application then sets the association metric to the result of the calculation of dividing the number of words common to both word sequence and idiom template by the number of words contained in the idiom template. Thus, the media guidance application determines that the idiom template contains three words (e.g., “burn,” “midnight,” and “oil”). The media guidance application then sets the association metric to the result of dividing the number of words common to both the idiom template and word sequence (e.g., two words) by the number of words in idiom template (e.g., three words). Thus, the media guidance application sets the association metric to the result of the calculation (i.e., 0.67).

Process 1000 then continues to 1008, where the media guidance application retrieves a default similarity threshold from storage 608. The default similarity threshold indicates the minimum association metric that the word sequence and idiom template are to have in order for the media guidance application to consider the word sequence to correspond to the idiom associated with the idiom template. Thus, the media guidance application retrieves the default value (e.g., 0.7) for further calculations.

Process 1000 then continues to 1010, where the media guidance application retrieves a measure of how frequently the idiom is misstated. The media guidance application queries the idiom dictionary stored in storage 608 to determine that the idiom “burn the midnight oil” corresponds to three misstated variations of the idiom, such as “burning midnight oil.” Thus, the media guidance application determines the measure by dividing the number of variations of the idiom “burn the midnight oil” (e.g., 3) by the average number of variations per idiom in the dictionary of idioms (e.g., 1.8). Therefore, the media guidance application sets the measure of how frequently the idiom is misstated to 1.67. Process 1000 then continues to 1012.

If, at 1012, the media guidance application determines that the measure of how frequently the idiom is misstated is above a threshold, process 1000 continues to 1014, otherwise, process 1000 continues to 1016. Control circuitry determines a threshold for decreasing the default similarity threshold so as to account for the fact that idioms that have many variations are more difficult to detect in sequences of words than idioms that take on only one form. Thus, the media guidance application determines that the threshold is 1.5, and the media guidance application compares this threshold to the measure of how frequently the idiom is misstated (e.g., 1.67).

At 1014, the media guidance application decreases the default similarity threshold to account for the fact that idioms with many variations are more difficult to detect. Thus, the media guidance application decreases the default similarity threshold from 0.7 to 0.6. Process 1000 continues to 1016.

At 1016, the media guidance application determines whether the similarity metric matches or exceeds the default similarity threshold. Thus, the media guidance application compares the similarity metric (e.g., 0.67) to the updated value of the default similarity metric (e.g., 0.6). If the similarity metric matches or exceeds the updated value of the default similarity metric, process 1000 continues to 1018. Otherwise, process 1000 returns to 1002 to detect the next trigger word.

At 1018, the media guidance application provides the definition of the idiom to the user. The media guidance application queries the dictionary of idioms to identify the definition of the idiom “burn the midnight oil” corresponding to the trigger word (e.g., “midnight”) and provides the definition (e.g., “read, study, or work late into the night”) on display 612.

It should be noted that processes 800-1000 or any step thereof could be performed on, or provided by, any of the devices shown in FIGS. 1-3 and FIGS. 6-7. For example, any of processes 800-1000 may be executed by the media guidance application (FIG. 6) as instructed by control circuitry implemented on user equipment 702, 704, and/or 706 (FIG. 7) in order to ensure media borrowed by a user is returned to its rightful owner. In addition, one or more steps of processes 800-1000 may be incorporated into or combined with one or more steps of any other process or embodiment.

It is contemplated that the steps or descriptions of each of FIGS. 8-10 may be used with any other embodiment of this disclosure. In addition, the steps and descriptions described in relation to FIGS. 8-10 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to in FIGS. 1-3 and FIGS. 6-7 could be used to perform one or more of the steps in FIGS. 8-10.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM device, or a random access memory, such as a hard drive device or a computer diskette, having a computer-readable program code stored thereon. It should also be understood that methods, techniques, and processes involved in the present invention may be executed using processing circuitry. For instance, detecting that a word that satisfies a user-specific criterion has been encountered by the user during consumption of media may be performed, e.g., by processing circuitry 606 of FIG. 6. The processing circuitry, for instance, may be a general purpose processor, a customized integrated circuit (e.g., an ASIC), or a field-programmable gate array (FPGA) within user equipment 700, media content source 716, or media guidance data source 718. For example, a user profile, as described herein, may be stored in, and retrieved from, storage 608 of FIG. 6, or media guidance data source 718 of FIG. 7. Furthermore, processing circuitry, or a computer program, may update settings associated with a user, such as a register of media assets stored on a user's user equipment, updating the information stored within storage 608 of FIG. 6 or media guidance data source 618 of FIG. 6.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for improving a vocabulary of a user by providing, to the user, a definition of a word encountered by the user during media consumption when a profile of the user reflects an insufficient understanding of the word, the method comprising:
accessing the profile of the user;
detecting that the word that satisfies a user-specific criterion has been encountered by the user during consumption of media by the user;
determining a level of exposure that the user has had to the word based on an entry corresponding to the word in the profile;
comparing the level of exposure to an exposure criterion;
determining, based on the comparing, that the level of exposure reflects an insufficient understanding of the word; and
in response to determining that the level of exposure reflects an insufficient understanding of the word, providing a definition of the word to the user.

2. The method of claim 1, wherein the method further comprises obtaining a value of the user-specific criterion by:
receiving a user request to specify a user-defined value for the user-specific criterion, wherein the user-specific criterion describes a minimum word length;
receiving the user-defined value; and
updating the value of the user-specific criterion with the user-defined value, wherein detecting that the word that satisfies the user-specific criterion has been encountered by the user during consumption of media by the user comprises determining that the word has a length of characters that equals or exceeds the minimum word length

3. The method of claim 1, wherein the method further comprises obtaining a value of the user-specific criterion by:
storing, in the profile, a history of words encountered by the user during media consumption, wherein the history is comprised of each encountered word, and wherein a given word of the history of words corresponds to a characteristic value that conveys a likelihood that the user may insufficiently understand the given word;
computing a mean characteristic value for a set of words of the history of words;
computing a standard deviation of the characteristic value for the set of words of the history of words;
computing a recommended value based on the mean characteristic value and the standard deviation of the characteristic value; and
updating the value of the user-specific criterion with the recommended value.

4. The method of claim 1, wherein detecting that the word that satisfies a user-specific criterion has been encountered by the user further comprises:
detecting a sequence of words;
comparing the sequence of words to a plurality of idiom templates comprised of terms;
determining an association metric relating to a similarity between the sequence of words and the idiom template;
determining whether the association metric meets or exceeds a similarity threshold; and
in response to determining that the association metric meets or exceeds the similarity threshold, providing, to the user, an idiom associated with the idiom template and an idiom definition associated with the idiom template.

5. The method of claim 4, wherein determining whether the association metric meets or exceeds the similarity threshold comprises:
determining that an idiom associated with the idiom template is frequently misstated in media; and
decreasing the similarity threshold in response to the determining that the idiom associated with the idiom template is frequently misstated in media.

6. The method of claim 1, further comprising:
detecting that a second word that satisfies the user-specific criterion has been encountered by the user during consumption of media by the user;
determining a second level of exposure that the user has had to the second word based on an entry corresponding to the second word in the profile;
comparing the second level of exposure to the exposure criterion;
determining, based on the comparing, that the second level of exposure reflects a sufficient understanding of the second word;
monitoring whether the user accessed a definition associated with the second word after the user encountered the word; and
in response to detecting that the user accessed the definition associated with the second word, modifying at least one of the value of the user-specific criterion and the value for the exposure criterion.

7. The method of claim 1, wherein providing the definition of the word to the user further comprises:
determining a pause duration, wherein the pause duration is determined by decreasing a default pause duration when the level of exposure meets or exceeds a predefined threshold, and increasing the default pause duration when the level of exposure does not meet or exceed the predefined threshold; and
pausing the media, while providing the definition of the word to the user, for a duration of time based on the determined pause duration.

8. The method of claim 1, further comprising:
monitoring, using the profile of the user, a web history of the user, wherein the web history is comprised of hyperlinks;
determining an exposure of the user to a word present in a document referenced by a hyperlink of the web history; and
in response to the determining the exposure of the user, updating the level of exposure that the user has had to the word based on the exposure of the user to the word present in a document.

9. The method of claim 1, further comprising,
receiving, in response to providing the definition of the word to the user, an indication from the user that the user had understood the meaning of the word before the definition of the word was provided to the user; and
in response to receiving the indication from the user, decreasing the number of definitions of words provided to the user for words which the user sufficiently understands, by modifying at least one of the value of the user-specific criterion and the value of the exposure criterion.

10. The method of claim 1, further comprising,
receiving, in response to providing the definition of the word to the user, an indication from the user that the user did not understand the meaning of the word after the definition was provided to the user; and
in response to receiving the indication from the user, retrieving an expanded definition of the word, wherein the expanded definition contains further information for allowing the user to increase the understanding of the word.

11. A system for improving a vocabulary of a user by providing, to the user, a definition of a word encountered by the user during media consumption when a profile of the user reflects an insufficient understanding of the word, the system comprising:
communications circuitry; and
control circuitry configured to:
access, using the communications circuitry, the profile of the user;
detect that the word that satisfies a user-specific criterion has been encountered by the user during consumption of media by the user;
determine a level of exposure that the user has had to the word based on an entry corresponding to the word in the profile;
compare the level of exposure to an exposure criterion;
determine, based on the comparing, that the level of exposure reflects an insufficient understanding of the word; and
in response to determining that the level of exposure reflects an insufficient understanding of the word, provide a definition of the word to the user.

12. The system of claim 11, wherein the control circuitry is further configured to obtain a value of the user-specific criterion, and wherein the control circuitry is further configured, when obtaining the value of the user-specific criterion, to:
receive a user request to specify a user-defined value for the user-specific criterion, wherein the user-specific criterion describes a minimum word length;
receive the user-defined value; and
update the value of the user-specific criterion with the user-defined value, wherein the control circuitry is further configured, when detecting that the word that satisfies the user-specific criterion has been encountered by the user during consumption of media by the user, to determine that the word has a length of characters that equals or exceeds the minimum word length.

13. The system of claim 11, wherein the control circuitry is further configured to obtain a value of the user-specific criterion, and wherein the control circuitry is further configured, when obtaining the value of the user-specific criterion, to:
store, in the profile, a history of words encountered by the user during media consumption, wherein the history is comprised of each encountered word, and wherein a given word of the history of words corresponds to a characteristic value that conveys a likelihood that the user may insufficiently understand the given word;
compute a mean characteristic value for a set of words of the history of words;
compute a standard deviation of the characteristic value for the set of words of the history of words;
compute a recommended value based on the mean characteristic value and the standard deviation of the characteristic value; and
update the value of the user-specific criterion with the recommended value.

14. The system of claim 11, wherein the control circuitry is further configured, when detecting that the word that satisfies the user-specific criterion has been encountered by the user further comprises, to:
detect a sequence of words;
compare the sequence of words to a plurality of idiom templates comprised of terms;
determine an association metric relating to a similarity between the sequence of words and an idiom template;
determine whether the association metric meets or exceeds a similarity threshold; and
in response to determining that the association metric meets or exceeds the similarity threshold, provide, to the user, an idiom associated with the idiom template and an idiom definition associated with the idiom template.

15. The system of claim 14, wherein the control circuitry is further configured, when determining whether the association metric meets or exceeds the similarity threshold comprises, to:
determine that an idiom associated with the idiom template is frequently misstated in media; and
decrease the similarity threshold in response to the determining that the idiom associated with the idiom template is frequently misstated in media.

16. The system of claim 11, wherein the control circuitry is further configured to:
detect that a second word that satisfies the user-specific criterion has been encountered by the user during consumption of media by the user;
determine a second level of exposure that the user has had to the second word based on an entry corresponding to the second word in the profile;
compare the second level of exposure to the exposure criterion;
determine, based on the comparing, that the second level of exposure reflects a sufficient understanding of the second word;
monitor whether the user accessed a definition associated with the second word after the user encountered the word; and
in response to detecting that the user accessed the definition associated with the second word, modify at least one of the value of the user-specific criterion and the value for the exposure criterion.

17. The system of claim 11, wherein the control circuitry is further configured, when providing the definition of the word to the user, to:
determine a pause duration, wherein the pause duration is determined by decreasing a default pause duration when the level of exposure meets or exceeds a predefined threshold, and increasing the default pause duration when the level of exposure does not meet or exceed the predefined threshold; and
pause the media, while providing the definition of the word to the user, for a duration of time based on the determined pause duration.

18. The system of claim 11, wherein the control circuitry is further configured to:
monitor, using the profile of the user, a web history of the user, wherein the web history is comprised of hyperlinks;
determine an exposure of the user to a word present in a document referenced by a hyperlink of the web history; and
in response to the determining the exposure of the user, update the level of exposure that the user has had to the word based on the exposure of the user to the word present in the document.

19. The system of claim 11, wherein the control circuitry is further configured to:
receive, in response to providing the definition of the word to the user, an indication from the user that the user had understood the meaning of the word before the definition of the word was provided to the user; and
in response to receiving the indication from the user, decrease the number of definitions of words provided to the user for words which the user sufficiently understands, by modifying at least one of the value of the user-specific criterion and the value of the exposure criterion.

20. The system of claim 11, wherein the control circuitry is further configured to:
receive, in response to providing the definition of the word to the user, an indication from the user that the user did not understand the meaning of the word after the definition was provided to the user; and
in response to receiving the indication from the user, retrieve an expanded definition of the word, wherein the expanded definition contains further information for allowing the user to increase the understanding of the word.

21-50. (canceled)
